(19) United States
(12) Patent Application Publication
(10) Pub. No.: US 2007/0166008 A1
(43) Pub. Date: Jul. 19, 2007

(54) DIGITAL INFORMATION RECORDING MEDIUM, DIGITAL INFORMATION RECORDING AND REPRODUCING APPARATUS AND RECORDING AND REPRODUCING METHOD THEREOF

(76) Inventors: Tatsuaki Iwata, Kawasaki-shi (JP); Shinichiro Koto, Kokubunji-shi (JP); Masahiro Nakashika, Kawasaki-shi (JP); Tomoo Yamakage, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/620,844

(22) Filed: Jan. 8, 2007

(30) Foreign Application Priority Data
Jan. 17, 2006 (JP) 2006-009128

(51) Int. Cl. H04N 7/00

(52) U.S. Cl. 386/95

(57) ABSTRACT

In a recording medium in which a rewritable video manager and video objects are recorded, the video objects comprise video elementary streams defined in H.264, and the video manager includes information of the video objects having described therein a video object type in which a seamless flag and a seamless extension flag are described which show that the video objects are continuously and seamlessly reproduced for each of the video objects.

### CROSS-REFERENCE TO RELATED APPLICATIONS

This application is based upon and claims the benefit of priority from prior Japanese Patent Application No. 2006-009128, filed Jan. 17, 2006, the entire contents of which are incorporated herein by reference.

### BACKGROUND OF THE INVENTION

1. Field of the Invention

The present invention relates to a digital information recording medium and a recording and reproducing apparatus for recording and reproducing digital information, and a method for recording digital information on the recording medium and reproducing the information from the recording medium, and particularly to an optical disk on which video data are recorded which disc is capable of seamlessly reproducing the video data even after the edition processing of the video, a method for seamlessly reproducing the video data from the optical disk and a reproducing apparatus thereof, and a method for seamlessly and reproducibly recording the video data on this optical disk, and a recording apparatus thereof.

2. Description of the Related Art

Recording media having a large recording capacity such as optical disks such as DVD (digital versatile disk) or HDD (hard disk drive) have been developed. Along with the prevalence of such media, recording apparatuses are becoming prevalent which code video and audio signals such as television broadcasting or the like to digital video data and audio data and which record digital data on the recording medium for a long time.

In a series of recording processing at the time of recording video and audio data, there is provided, as a method for managing the recording data, a method for compressing and coding video and audio (audio) data, multiplexing compressed video and audio in a MPEG-PS mode and handling the video and audio as an video object (EVOB). In this method, attribute information of video data or audio data and information associated with time stamp are recorded on the disk as management information for each video object. At the time of reproduction, the video and audio data continuously reproduced on the basis of the management information.

With respect to the video objects which are recorded on the disks such as DVD or HDD disks in this manner, a smooth reproduction can be realized in a reproduction of a single video object (EVOB). On the other hand, in a continuous reproduction of a plurality of video objects (EVOB), it is considered to be not easy to seamlessly reproduce video data. There is a case in which only by means of a simple decoding processing of different video objects in a continuous manner, an overflow or an underflow of buffers are generated on the decoding side, and an inconsistency such as absence of reference picture is generated.

In a recording and reproducing apparatus disclosed in JP-A 2001-160945 (KOKAI), a seamless playback is realized by adding the following definition and processing to the video objects and management information. Specifically, a seamless flag (SML_FLG) is defined which shows whether or not each of the video objects is seamlessly connected to a video object (EVOB) which comes immediately ahead for each of the video objects (EVOB). This seamless flag (SML_FLG) is described in the management information. In order to satisfy a seamlessly reproducible state, a buffer state in the foregoing video object (EVOB) is maintained with respect to the video data whereas a code amount is allocated so that no buffer error is generated even when the following video object (EVOB) is input. Furthermore, with respect to the video data, audio data and other data included in the video objects (EVOB), a shift is generated in some cases in the value of the system clock reference (SCR) between the video objects (EVOB). Consequently, information for absorbing the shift is recorded as seamless information with the result that information can be reproduced by occasionally changing over the system time clock (STC) within the apparatus on the basis of the aforementioned seamless information at the reproduction processing time. In the case where the seamlessly reproducible state can be guaranteed through such measures, the seamless flag is described on the recording medium as management information.

Furthermore, JP-A 2001-160945 (KOKAI) discloses a technology for guaranteeing a seamless playback with the video object after the resumption of reproduction in the case where a temporary suspension is performed in a primarily continuous recording processing. In contrast to this JP-A 2001-160945 (KOKAI), JP-A 2000-152181 (KOKAI) discloses an operation for realizing a seamless playback after the deletion of a part of a certain video object (EVOB). In the seamless playback disclosed in JP-A 2000-152181 (KOKAI), by re-encoding an end of the foregoing video object (EVOB) and a front portion of the following video object (EVOB), a difference in the buffer states generated between the video objects (EVOB) is eliminated to eliminate buffer errors and to eliminate a reference picture loss as well. Furthermore, in the same manner as JP-A 2001-160945 (KOKAI), a seamless playback is realized as a whole system by recording seamless information for absorbing a shift in the system time clock (STC) of each of the data streams.

JP-A 2001-160945 (KOKAI) or JP-A 2000-152181 (KOKAI) primarily discloses maintenance of a buffer state and absorption of a shift of a system clock reference (SCR) as operations which enable a seamless playback by assuming the MPEG-2 (ISO/IEC13181-2) in the compression coding of the video data.

However, in the case where either a coding format H.264 (simply referred to as H.264) which is internationally standardized at the ITU-T (International Telecommunication Union-Telecommunication Standardization) as a compression coding format of the video data, the H.264 or the MPEG-4AVC (simply referred to as MPEG-4AVC) which is defined in ISO/IEC14496-10 is used, there arises a case in which a seamless playback cannot be realized only by means of the prior art.

In this coding format, as compared with the MPEG-2, the coded bit stream includes a plurality of parameters having a dependency relation with previous and following parameters in the bit stream. For example, there are available parameters such as picture order count, num or the like. In these parameters, association with the previous and the following parameters or an increment portion thereof are regulated, and still, these parameters are used in a primary processing in the reproduction processing such as the reference picture management or the like. Consequently, an inconsistency generated in parameters which do not observe the standard is judged to be an error in a normal decoder, with the result that there arises a possibility that an inconsistency is generated in reproduction.

In the case where video data are continuously encoded and recorded, the inconsistency is not normally generated. However, in the case where the bit stream is partially deleted, there is a possibility that the inconsistency of the parameters is generated.

In the same manner as the MPEG-2, it is possible to eliminate the inconsistency of the aforementioned parameters in the re-encoding processing. However, the parameters which become a problem are parameters which continuously change over the whole bit stream. Thus, it is difficult to correct the video data only in the re-encoding of the part like the video data which are compressed in the MPEG-2. There is a possibility that the re-encoding processing becomes necessary over the whole of the following video object. In such re-encoding processing, there is a problem in that a processing cost at the edition time for realizing a seamless playback is largely increased.

On the other hand, it is possible to deal with the problem of the inconsistency of the aforementioned parameters by coding in the picture format which is regularly referred to as the IDR picture at the time of coding the input video data in advance in the aforementioned coding format. The IDR picture refers to an instantly decodable picture which is defined in the aforementioned coding format. When the IDR picture is present with respect to the aforementioned continuous parameters, the value of the parameter is initialized at that time. Thus, the edition point is defined as a location where the IDR picture is present, and the front of the following video object is set to begin from the IDR picture. As a consequence, as described already, a seamless playback is enabled only by conducting a processing such as the elimination of the inconsistency of the buffer state or the like. However, in this case, there arises a problem in that the time point at which edition is enabled is limited to the IDR picture in the bit stream, and freedom degree of the edition is lowered. In the bit stream in which the IDR picture is coded in a short cycle so that a minute edition is enabled, there is a problem in that the coding efficiency is largely lowered.

As described above, in the case where the coding is used which has a large number of continuous parameters having a dependency relation with the previous and the following parameters in the bit stream coded in the H.264 coding format (MPEG 4-AVC) as a coding form, there arises a problem in that an attempt of seamless playback will result in an increase in a load in the re-encoding or a large decrease in the coding efficiency.

### BRIEF SUMMARY OF THE INVENTION

According to an aspect of the present invention, there is provided a recording medium comprising:

an audio and video recording region defined between a lead-in region and a lead-out region, the audio and video recording region having a management information recording region on which rewritable management information is recorded, and an object group recording region on which rewritable video objects are recorded;

each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and

the management information recording region including a video manager which manages the video object, the video manager including stream information describing video attributes in which the video elementary stream is coded in a coding format defined in the H.264 or the MPEG-4, the video manager including video object information having describing a seamless flag and a seamless extension flag specifying that the video objects are continuously and seamlessly reproduced for each of the video objects, and a combination of the seamless flag and the seamless extension flag allows a two-level seamless playback.

According to an other aspect of the present invention, there is provided a reproducing apparatus which reproduces video data from a recording medium which comprises:

an audio and video recording region defined between a lead-in region and a lead-out region, the audio and video recording region having a management information recording region on which rewritable management information is recorded, and an object group recording region on which rewritable video objects are recorded;

each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and

the management information recording region including a video manager which manages the video object, the video manager including stream information describing video attributes in which the video elementary stream is coded in a coding format defined in the H.264 or MPEG-4, the video manager including video object information having describing a seamless flag and a seamless extension flag specifying that the video objects are continuously and seamlessly reproduced for each of the video objects, and a combination of the seamless flag and the seamless extension flag allows a two-level seamless playback, the apparatus comprising:

a reproducing unit which search the recording medium to read a video manager from the management information recording region, and read the video object from the object group recording region on the basis of this video manager;

a de-multiplexing unit which de-multiplexes the video object unit to separate it into a video elementary stream and an audio elementary stream;

a video buffer which stores the video elementary stream;

a video decoder which decodes the video elementary stream output from this video buffer to output the stream as a frame picture row;

an output unit which converts the frame picture row into a video signal to output the signal; and

a control unit which controls the video elementary stream to the video buffer in accordance with the seamless flag and the seamless extension flag.

According to yet other aspect of the present invention, there is provided a reproduction method for reproducing video data from a recording medium which comprises:

an audio and video recording region defined between a lead-in region and a lead-out region, the audio and video recording region having a management information recording region on which rewritable management information is recorded, and an object group recording region on which rewritable video objects are recorded;

each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and

the management information recording region including a video manager which manages the video object, the video manager including stream information describing video attributes in which the video elementary stream is coded in a coding format defined in the H.264, the video manager including video object information having describing a seamless flag and a seamless extension flag specifying that the video objects are continuously and seamlessly reproduced for each of the video objects, and a combination of the seamless flag and the seamless extension flag allows a two-level seamless playback, the method comprising:

searching the recording medium to read a video manager from the management information recording region, and read on the basis of this video manager the video object from the object group recording region;

de-multiplexing the video object unit to separate the video object unit into a video elementary stream and an audio elementary stream to store the video elementary stream;

storing the video elementary stream;

decoding the video elementary stream output from this video buffer to output the stream as a frame picture row;

converting the frame picture row into a video signal to output the signal; and

controlling the video elementary stream to the video buffer in accordance with the seamless flag and the seamless extension flag.

According to furthermore aspect of the present invention, there is provided a recording apparatus comprising:

an encoder which converts an audio signal and a video signal into an audio stream and a video elementary stream coded with the H.264;

a multiplexer part which stores the audio stream in an audio pack, stores the video elementary stream in a video pack to multiplex the audio pack and the video pack, and creates a video object unit in which an RDI pack for navigating a multiplexed pack sequence is arranged at the front;

a formatter which defines video objects which are respectively constituted of one or more video object units and which includes stream information and video object information to create a video manager which manages the video objects, wherein video attributes showing that the video elementary stream is coded with the coding format defined in the H.264 are described in the stream information, the video object information describes a video object type in which a seamless flag and a seamless extension flag are described which show that the video object can be continuously and seamlessly reproduced for each of the video objects, with the result that the formatter creates a video manager in which two levels of seamless playback are guaranteed with the combination of the seamless flag and the seamless extension flag;

a recording control part which records the video manager and the video objects on a recording medium comprising an audio and video recording region defined between lead-in and lead-out regions, the audio and video recording region including a rewritable management information recording region and a rewritable object group recording region; wherein the video manager is recorded on the management information recording region while the video objects are recorded on the object group recording region.

According to yet further aspect of the present invention, there is provided a recording method comprising the steps of:

encoding an audio signal and a video signal into an audio stream and a video elementary stream coded with the H.264;

storing the audio stream into an audio pack and storing the video elementary stream into a video pack to multiplex the audio pack and the video pack, thereby creating an RDI pack for navigating a multiplexed pack sequence in the video object unit which is arranged at the front;

formatting for defining two or two video objects respectively comprising one or more video object units, and creating a video manager which includes stream information and video object information and manages the video objects, wherein video attributes showing that the video elementary stream is coded with the coding format defined with the H.264 are described in the stream information, the video object information described a video object type in which a seamless flag and a seamless extension flag are described which show that the video objects can be continuously and seamlessly reproduced for each of the video objects, with the result that two levels of seamless playback are guaranteed with a combination of this seamless flag and the seamless extension flag;

recording the video manager and the video objects on a recording medium comprising an audio and video recording region defined between lead-in and lead-out regions, the audio and video recording region including a rewritable management information recording region and a rewritable object group recording region, wherein the video manager is recorded in the management information recording region, and the video objects are recorded on the object group recording region.

### BRIEF DESCRIPTION OF THE SEVERAL VIEWS OF THE DRAWING

FIG. 1 is a block diagram schematically showing a recording and reproducing apparatus according to one embodiment;

FIG. 2 is a block diagram schematically showing a recording processing unit shown in FIG. 1;

FIG. 3 is a block diagram schematically showing a reproduction processing unit shown in FIG. 1;

FIG. 4 is a schematic diagram schematically showing a layered structure of a recordable and erasable disk shown in FIG. 1;

FIG. 5 is a layered view schematically showing a structure of a management file which is recorded on an AV data management information recording region shown in FIG. 4;

FIG. 6 is a layered view showing a HDVR manager shown in FIG. 5;

FIG. 7 is a layered view showing a structure of an expansion movie AV file table (EX_M_AVFIT) shown in FIG. 6;

FIG. 8 is a schematic diagram showing a description of a video attribute shown in FIG. 7;

FIG. 9 is a layered view showing a structure of video object information (M_EVOBI) shown in FIG. 5;

FIG. 10 is a layered view showing a structure of a video time map (VTMAP) shown in FIG. 5;

FIG. 11 is a layered view showing a structure of video time map information (VTMAPI) shown in FIG. 10;

FIG. 12 is a layered view showing a structure of program chain information (PGCI) shown in FIG. 6;

FIG. 13 is a layered view showing a structure of movie sell information (M_CI) shown in FIG. 12;

FIG. 14 is a layered view showing a structure of a HR movie video recording file (HR_MOVIE.VRO) which is recorded on a VR object group recording region shown in FIG. 4;

FIG. 15 is a schematic diagram showing a relation among a video object unit (VOBU) shown in FIGS. 4 and 15, a program chain (PGC) as navigation data, a program (PG) and a cell (C);

FIG. 16 is a schematic diagram showing an example in which an original video object (EVOB) is divided and a part thereof is erased in a recording method according to one embodiment of the present invention;

FIG. 17 is a flowchart showing a processing procedure in the division and erasure of the original video object (EVOB) shown in FIG. 16;

FIG. 18 is a flowchart showing a processing procedure for realizing a seamless playback in a new video object (EVOB) divided from the original video object (EVOB) shown in FIG. 16;

FIG. 19 is an outline showing a concept of a conversion processing for realizing a semi-seamless state in the divided new video object (EVOB) shown in FIG. 16;

FIG. 20 is a view showing a processing flow of a seamless playback in a semi-seamless state in the divided new video object (EVOB) shown in FIG. 16; and

FIG. 21 is a view showing another processing flow of the seamless playback in a semi-seamless state in the divided new video object (EVOB) shown in FIG. 16.

### DETAILED DESCRIPTION OF THE INVENTION

Hereinafter, referring to the drawings when needed, there will be explained a digital information recording and reproducing apparatus and a recording medium thereof according to one embodiment of the invention.

### First Embodiment

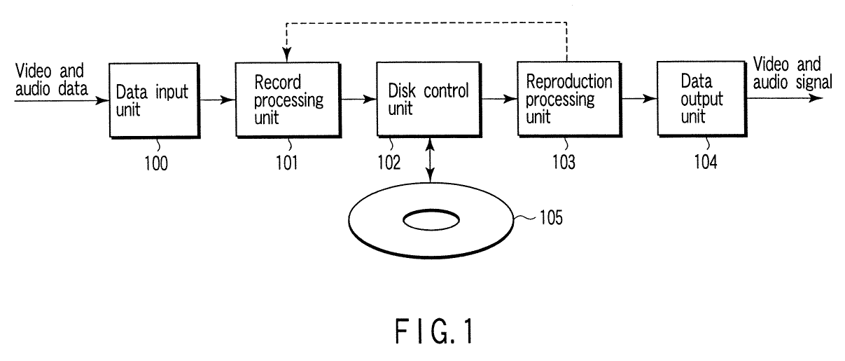

FIG. 1 is a block diagram schematically showing a recording and reproducing apparatus for recording and reproducing digital information according to a first embodiment.

As shown in FIG. 1, the recording and reproducing apparatus comprises a data input unit 100 for obtaining video and audio data input from a television tuner or an external video apparatus. Analog video and audio data input via this data input unit 100 are input to an encoding unit and a recording processing unit 101 including a formatter for creating management information. In this recording processing unit 101, in the coding format (H.264 or MPEG-4AVC defined in the ISO/IEC14496-10) which is internationally standardized in the designated coding format (ITU-T (International Telecommunication Union-Telecommunication Standardization)), analog video and audio data are encoded and multiplexed to be converted into a video elementary stream. At the recording processing unit 101, navigation data for navigating reproduction data at the time of reproduction processing of the multiplexed elementary stream are created at the formatter, with the result that the elementary stream signal and navigation data are recorded and accumulated in a data accumulation or storage unit 105, for example, a recordable optical disk or a hard disk via a disk control unit 102. The disk control unit 102 controls an optical disk or a hard disk as the data accumulation unit 105, receives a packetized elementary stream and navigation data from the recording processing to be written into the data accumulation unit 105, reads data of the data accumulation unit 105, and transmits the data to a reproduction processing unit 103 including the decoding unit.

At the reproduction time, the video object (EVOB) recorded on the optical disk or the hard disk as the data accumulation unit 105 and attribute information associated with this video object (EVOB) are transmitted to the reproduction processing unit 103 including the decoding unit. At this reproduction processing unit 103, the video data and the audio data are separated from the video object (EVOB), with the result that the video data and the audio data are subjected to decoding processing on the basis of the attribute information. The decoded video and audio data are output to the external apparatus such as a television or the like via an output unit 104.

### (Structure of Encoding Portion)

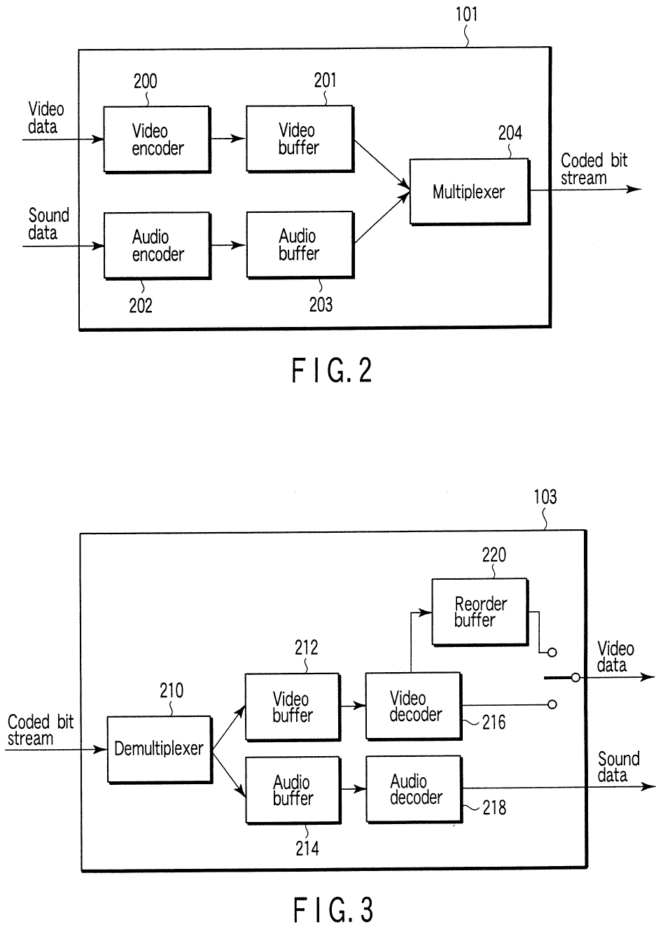

The recording processing unit 101 shown in FIG. 1 comprises, as shown in FIG. 2, a video encoder 200 and an audio encoder 202, as well as a video buffer 201 and an audio buffer 203. The input video data and the audio data are encoded in the coding format designated at the video encoder 200 and the audio encoder 202 to be accumulated in the video buffer 201 and the audio buffer 203, respectively. The video elementary stream accumulated in each of the buffers 201 and 203 is multiplexed with the multiplexer to be output as a multiplexed program stream.

### (Structure of Decoding Portion)

The reproduction processing unit 103 shown in FIG. 1 comprises a de-multiplexer 210, a video buffer 212 and an audio buffer 214, and a video decoder 216 and an audio decoder 218 with the result that the multiplexed program stream is input to the de-multiplexer 210 to be separated into a video stream and an audio stream. The separated elementary stream is accumulated in the video buffer 212 and the audio buffer 214, respectively, and the video stream and the audio stream data accumulated in the buffers 212 and 214 are sequentially supplied to the video decoder 216 and the audio decoder 218 to be decoded. The decoded video data are required to be adjusted in a reproduction order depending on the type of the decoded picture. Consequently, the data are input to a reorder buffer 220 depending on type of pictures. In the reorder buffer 220, the reproduction order is adjusted to be output. The decoded audio data are output from the audio decoder 218 one after another.

### (Explanation on Disk Structure)

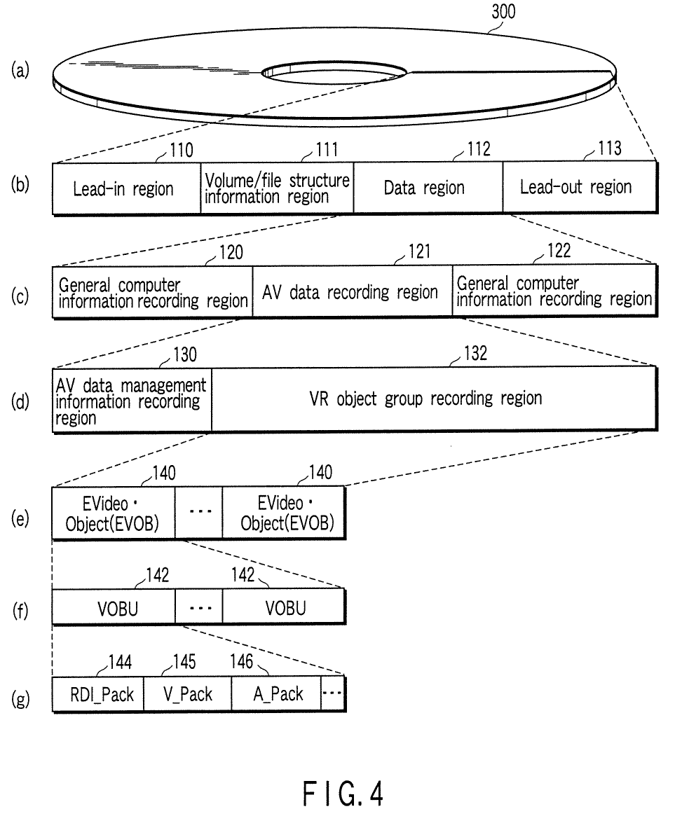

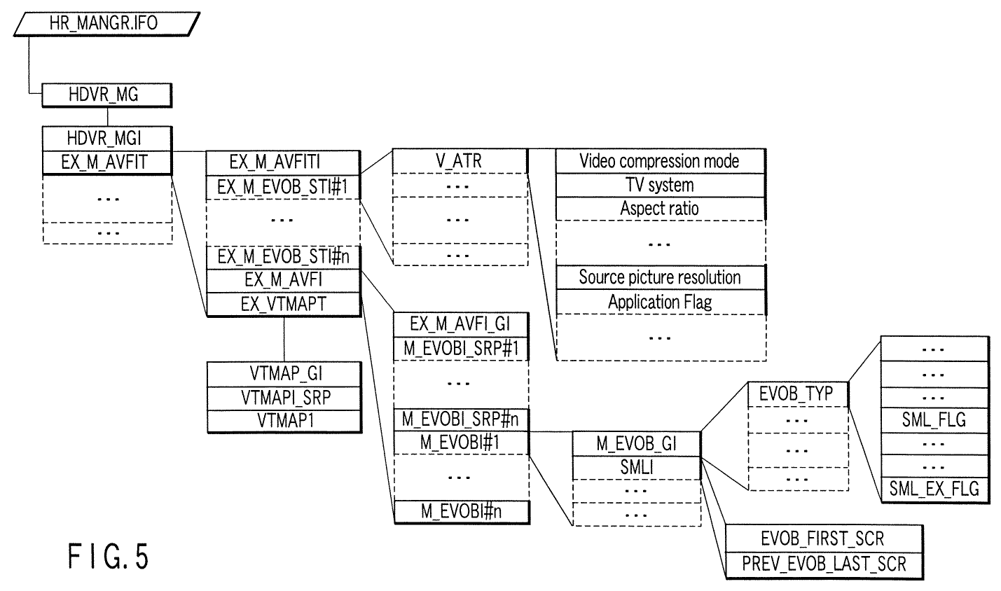

Next, by referring to FIG. 4, there will be explained a data structure of the data accumulation unit 105 shown in FIG. 1, particularly an optical disk in which to store, as a video object, the video stream coded in accordance with the format of the coding format (H.264 or MPEG-4AVC defined in ISO/IEC14496-10) which is internationally standardized at the ITU-T (International Telecommunication Union-Telecommunication Standardization).

Incidentally, when the hard disk as a recording medium is provided with the same structure as the data structure shown in FIG. 4, the hard disk is capable of storing the data stream in the video object (EVOB) in the same manner as the optical disk shown in FIG. 4. Furthermore, the hard disk is capable of storing the navigation data as management data in the management region of the video object. Consequently, the navigation data can be also stored in the hard disk in the same manner, particularly, without classifying the optical disk and the hard disk. An explanation thereof is omitted.

FIG. 4 is a view schematically showing a data structure according to one embodiment. As a representative example of a recordable or rewritable information recording medium, there are available a DVD disks (such as DVD±R, DVD±RW, DVD-RAM or the like which have a single recording layer or a plurality of recording layers and which are capable of reading data using a red laser having a wavelength of about 650 nm or a blue ray laser or a blue laser having a wavelength of about 405 nm) 300 as shown in FIG. 4(a). This disk 300 comprises a lead-in region 110 on the inner periphery of the disk 300 and a lead-out region 113 on the outer periphery of the disk 300, as shown in FIG. 4(b). There are also arranged a volume/file structure information region 111 on which the file system is stored and a data region 112 for actually recording the data file, between both the regions 110 and 113. The aforementioned file system comprises information which show where which file is stored.

The data region 112 includes, as shown in FIG. 4(c), regions 120 and 122 recorded by general computers, and a region 121 for recording AV data. The AV data recording region 121 includes an AV data management information region 130 having a video manager (VMG) file for managing AV data as shown in FIG. 4(d) and a VR object group recording region 132 in which to record an object data based on the video recording (VR) standard, namely, a file (VRO file) of a video object (EVOB: Extended Video Object) as shown in FIG. 4(e). The AV data management information region 130 and the VR object group recording region 132 are defined in a rewritable region.

On the VR object group recording region 132, as shown in FIG. 4(f), one or a plurality of video objects (EVOB) 140 are recorded. Each of the video objects (EVOB: Extended Video Object) 140 comprises one or more video object units (VOBU) 142. Here, the video object is simply referred to as a VOB in place of the EVOB in some cases. The video object units (VOBU) 142 are defined as a pack sequence in which a video pack 145 (V_Pack) and an audio pack 146 (A_Pack) are multiplexed which begin from a real time data information pack (RDI_PACK: Real-Time Data Information) 144 storing data for navigating the video object unit (VOBU) as shown in FIG. 4(g).

The real-time data information pack (RDI_PACK) 144, the video pack (V_Pack) 145, and the audio pack (A_Pack) 146 shown in FIG. 4(g) comprises a pack header and a data packet. On the pack header, a stream ID is described. On the packet of the RDI pack (RDI_PACK) 144, a sub-stream ID is further described. Furthermore, on the packet of the audio pack (A_Pack) 146, the sub-stream ID is described in accordance with the coding mode. Consequently, in the reproduction processing unit 103, respective packets can be differentiated and de-multiplexed with a combination of the stream ID and the sub-stream ID.

The management information recorded on the AV data management information region 130 will be explained by referring to FIGS. 5 through 13. In the volume/file structure information region, a layered structure of the disk 300 is described. A HDVR directory (not shown) is provided under a root directory. Under the HDVR directory, the file of the HDVR video manager (HDVR_MG), and the file of the backup (HDVMG Backup) thereof are provided as a management information file (HR_MANGER.INF) of DVD. Furthermore, information is described to the effect that a directory of the video object (HDVR_EVOB) is provided. The directory of the video object (HDVR_EVOB) includes files of the above-described one or a plurality of video objects (EVOB) 140 which are recorded on the VR object group recording region 132 shown in FIG. 4. Furthermore, the file of the HD video manager (HDVR_VMG) is recorded on the AV data management information recording region 130 shown in FIG. 4.

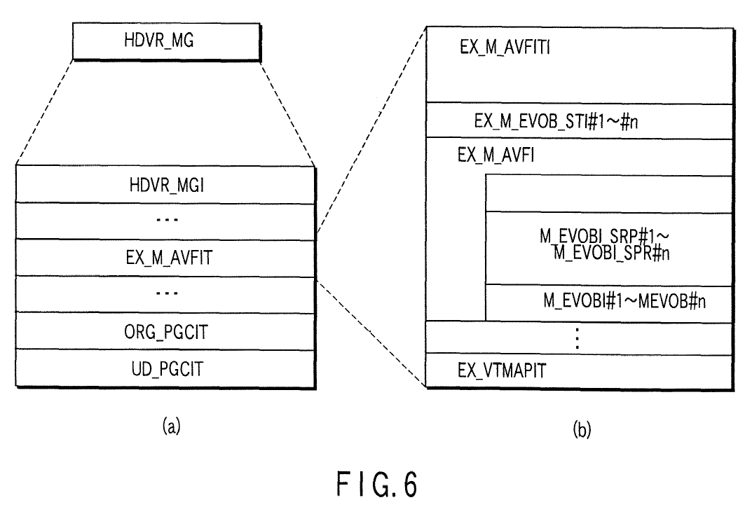

The DVD management information file (HR_MANAGER.IFO) recorded on the AV data management information recording region 130 comprises HDVR video manager (HDVR_MG) shown in FIGS. 5 and 6A. This HDVR video manager (HDVR_MG) includes HDVR manager general information (HDVR_MGI) while this HDVR manager general information (HDVR_MGI) includes a management information management table (MGI_MAT) and play list search pointer table (EX_PL_SRPT) (both not shown). The management information management table (MGI_MAT) includes disk management differentiation information (VMG_ID), an end address (representative of an address from the front of the HR_MANAGER_EA: DHVR_MG file to the end of the EX_MNFIT) of the HDVMG file information (HR_MANAGER_IFO), the end address (representative of an address from the front of the HDVR_MGI_EA: DHVR_MG file to the end of the HDVR_MGI) of the management information (HDVR_MGI), version information, resume information (DISC_RSM_MRKI) of the disk, representative picture information (EX_DISC_REP_PICI) of the disk, a start address (ESTR_FIT_SA) of the stream object management information, a start address (EX_ORG_PGCIT_SA) of the original program chain information, and a start address (EX_UD_PGCI_SA) of the user definition program chain information table. In the resume mark information (DISC_RSM_MRKI), information is described for resuming the reproduction which is interrupted in the case of the reproduction of the whole disk. In the representative picture information (EX_DISC_REP_PICI) of the disk, information associated with the representative picture is described.

The play list search pointer table (EX_PL_SRPT) includes search pointers (EX_PL_SRP#1 through #n) to each play list. In each of the search pointers (EX_PL_SRP), a resume marker (PL_RSM_MRKI: a marker showing up to which place the reproduction is conducted at the time of the interruption of the reproduction) for each play list is described. In this resume marker (PL_RSM_MRKI), information for resuming the reproduction is recorded.

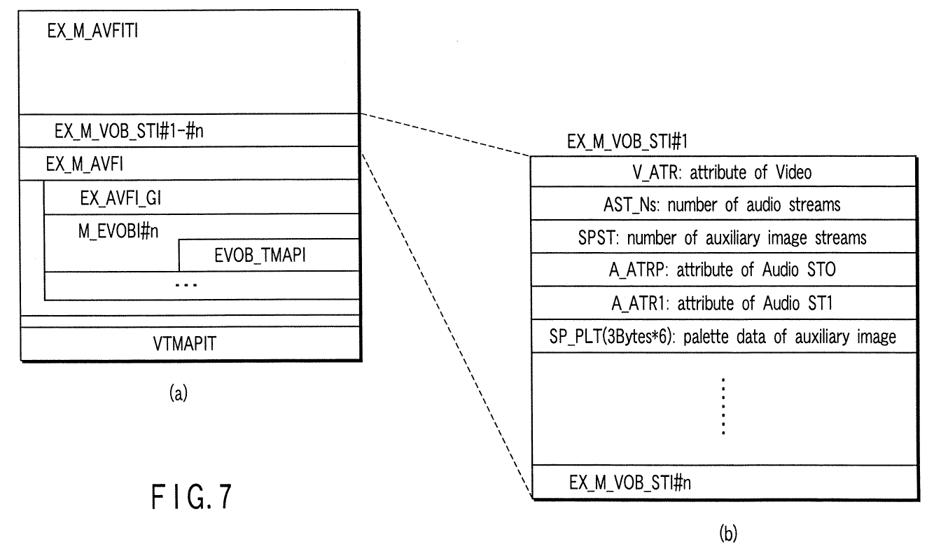

Furthermore, the HDVR video manager (HDVR_MG) as a management information file (HR_MANGER.IFO) of the DVD comprises a movie AV file information table (EX_M_AVFIT) as shown in FIGS. 5A and 6. This movie AV file information table (EX_M_AVFIT) includes movie AV file table information (EX_M_AVFIT) as shown in FIG. 6(b) and 7(a). In the movie AV file table information (EX_M_AVFIT) thereof, the number of information (M_EVOB_STI#1 through #n: n is an integer) of the video object stream for movies included in the movie AV file information table (EX_M_AVFIT) and the number of information (M_EVOBI#1 through #n: n is an integer) of the video objects within the movie AV file information (EX_M_AFVI) are described. The number of the video object information (M_EVOI#1 through #n: n is an integer) corresponds to n video objects (EVOB) recorded in the VR object group recording region. As will be explained later, management information for each video object (EVOB) is described.

The movie AV file information table (EX_M_AVFIT) further includes information (EX_M_EVOBI#1 through #n) of the video object stream for movies and movie AV file information (EX_M_AVFI) as shown in FIGS. 5 and 6(b). Furthermore, the movie AV file information table (EX_M_AVFIT) includes a video time map table (EX_VTNAPIT) which will be explained later.

In the information (EX_M_EVOBI#1 through #n) of the video object stream for movies, information of the stream is described for each of the video objects (EVOB) as shown in FIGS. 5, 7(a) and 7(b). That is, in the information (EX_M_BVOBI#1) of the video object streams for movies, the attribute (V_ATR) of the video included in the video object (EVOB), the number of audio streams included in the video object (EVOB) and the number (SPST_Ns) of the auxiliary video streams included in the video object (EVOB) are described. Furthermore, in the information (EX_M_EVOBI#1) of the is video object stream for movies, the audio attribute (A_ATR0) of the audio stream #0 and the audio attribute (A_ATR1) of the audio stream #1 are described. The display information (SP_PLT) is described with respect to the auxiliary video palette data (luminance and color information). The information (EX_M_EVOBI#n) of the video object stream for the n-th movie is also described in the same manner as the information (EX_M_EVOBI#1) of the video object stream for the first movie. The information (EX_M_VOBI) of this video stream is described in an order of stream numbers. As will be explained later, in the information (M_VOB_GI) of the movie video object, the number (M_VOB_STIN) of the information of the video object stream used in the video object (EVOB) is described. Consequently, when the video object information (M_VOB_GI) is referred to, the stream information is referred to from the number (M_VOB_STIN) of the stream information with the result that the video attribute (V_ATR) is obtained, and the coding mode is specified.

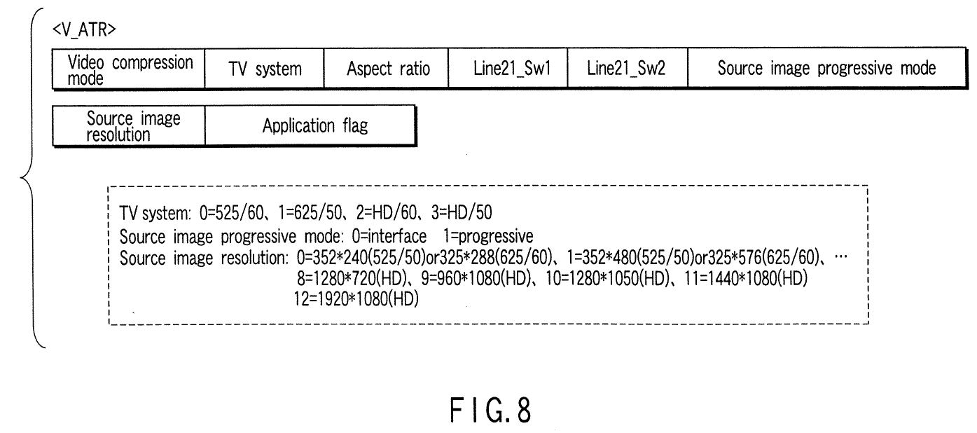

As shown in FIG. 8, in the video attribute (V_ATR), it is described as to whether the coding mode, namely the compressing mode of the video is MPEG-1, MPEG-2, MPEG 4-AVC or VC-1. Furthermore, in the video attribute (V_ATR), the scanning line number of the TV system is described, and it is also described in the attribute as to whether the video is a hi-vision or a high definition (HD). It is also described as to whether the source picture is a progressive picture or not. Furthermore, the aspect ratio, the resolution of the source picture, and applications are also described therein. In the same manner, in the audio attribute (A_ATR0) of the audio stream #0 and the audio attribute (A_ATR1) of the audio stream #1, the coding mode of the audio (dolby AC3, MPEG-1, MPEG-2, and linear PCM), the number of audio channels, quantization/DRC and application types are described. By referring to this video attribute (V_ATR), the coding mode of the video elementary stream (V_ES) which is stored in the video packet (V_PKT) within the video pack (V_PCK) (accurately the video pack (V_PAK)) constituting a video object unit (VOBU) can be recognized by the reproduction processing unit 103 of the reproduction apparatus.

As shown in FIGS. 5 and 6(a) and 6(b), with respect to the movie AV file information (EX_M_AVFI) included in the movie AV file information table (EX_M_AVFIT), as shown in FIG. 6(b), general information (EX_M_AVFI_GI) of the movie AV file information is described at the outset. In this general information (EX_M_AVFI_GI), the number of search pointers (M_EVOBI_SRP#1 through M_EVOBI_SRP#n) of the video object information for movies described following the general information (EX_M_AVFI_GI) is described. This number of search pointers (M_EVOBI_SRP#1 through M_EVOBI_SRP#n) corresponds to the number (n) of the video objects (EVOB) described in the VR object group recording region 132 shown in FIG. 4(d). In the search pointer (M_EVOBI_SRP#n) a start address of the video object information (M_EVOBI#1 through M_EVOBI#n) for movies in which the number corresponding to the number (n) of the video objects (EVOB) is prepared is described in a logical block number from the table (M_AVFIT). Consequently, the numbers of the search pointers (M_EVOBI_SRP#n) are defined in accordance with the numbers of the video objects (EVOB) described in the recording order of the video objects (EVOB) described in the VR object group recording region 132. A start address of the information (M_EVOBI#1 through M_EVOBI#n) of the video object for movies can be acquired by designating the number of the search pointers (M_EVOBI_SRP#n) and the information (M_EVOBI#1 through M_EVOBI#n) of the video object for movies can be obtained.

General information (M_EVOB_GI) is described in each of the information (M_EVOBI#1 through M_EVOBI#n) of the video object for movies in the beginning as shown in FIG. 9. In the general information (M_EVOB_GI) of the video object for movies, the type (EVOB_TYP) of the video object (EVOB) is described. In this type (EVOB_TYP), a type of the video object (EVOB) is described. In this type (EVOB_TYP), a temporary erase (TE) is described which shows whether the video object (EVOB) is in a normal state or is temporarily erased. Here, when symbol “0b” is described in the temporary erase (TE), the video object (EVOB) is in the normal state (no erasure). On the other hand, when symbol “1b” is described in the temporary erase (TE), the video object (EVOB) is temporarily erased. By referring to this temporary erase (TE), the reproduction side can recognize whether or not the part of the video object (EVOB) is erased by means of the edition thereof.

Furthermore, in this type (EVOB_TYP), a seamless flag (SML_FLG) is described which shows whether or not the video object (EVOB) can be seamlessly reproduced following the previous video object (EVOB) in the case where the video object (EVOB) is reproduced following the previous video object (EVOB) which comes before in terms of time by referring to this video object (EVOB). In the seamless flag (SML_FLG), symbol “0b” showing that the reproduction is not a seamless playback and symbol “1b” showing that the reproduction is a seamless playback are described. Furthermore, in this type (EVOB_TYP), a seamless extension flag (SML_EX_FLG) is further described. In the case where symbol “1b” is described in the seamless flag (SML_FLG), and symbol “1b” is described in the seamless extension flag (SML_EX_FLG), a perfect seamless playback is realized between the continuous video objects (EVOB). In the case where symbol “1b” is described in the seamless flag (SML_FLG) and symbol “0b” is described in the seamless extension flag (SML_EX_FLG), a so-called semi-seamless playback is realized between the continuous video objects (EVOB). Furthermore, in the case where symbol “0b” is described in the seamless flag (SML_FLG) and symbol “0b” is described in the seamless extension flag (SML_EX_FLG), a non-seamless state is maintained in which the seamless playback cannot be realized between continuous video objects (EVOB).

In the non-seamless state, it is possible to conduct reproduction free from an overflow in buffers by detecting the seamless flag (SML_FLG=0) and the seamless extension flag (SML_EX_FLG=1). That is, in the case where the video elementary stream of the next video object (VOBU) is input following the video elementary stream of a certain video object (VOBU), the input of the video elementary stream of the next video object is temporarily inhibited from being input to the video buffer 212 shown in FIG. 3. An overflow of the video elementary stream is prevented from being generated in the video buffer 212 by inputting the video elementary stream of the next video object (EVOB) to the video buffer 212 after the output of the video elementary stream of the previous video object (EVOB). However, the video picture to be output is temporarily interrupted to be reproduced.

In the semi-seamless state (SML_FLG=1, SML_EX_FLG=0), to the end of the video elementary stream of the previous video object (EVOB), a sequence end code (SEQ_END_CODE: end_of_seq_rbsp) indicating end of sequence is added. In the case where this sequence end code (SEQ_END_CODE) is detected in the state in which the seamless flag (SML_FLG=1) and the seamless extension flag (SML_EX_FLG=0) are detected, the input of the video elementary stream of the next video object (EVOB) to the buffer 201 is allowed. However, the video elementary stream of the video object (EVOB) is continuously input to the video buffer 212. While the inside parameter remains inconsistent, pictures are reproduced substantially seamlessly. However, depending on the performance of the decoder, there is a possibility that the picture which is reproduced seamlessly is temporarily interrupted.

In the perfect seamless state (SML_FLG=1, SML_EX_FLG=1), a sequence end code (SEQ_END_CODE: end_of_seq_rbsp) is provided at the end of the previous video object (EVOB). At the front of the video elementary stream of the video object (EVOB) following the previous video object (EVOB), the IDR picture (IDR) included in the video object (EVOB) is arranged. Furthermore, on the basis of the IDR picture (IDR), the parameters of the following video elementary stream are described so as to be consistent with the IDR. That is, the previous video object (EVOB) and the video object (EVOB) following the previous video object are appropriately coded, and the parameters thereof are defined. Consequently, in the perfect seamless state (SML_FLG=1, SML_EX_FLG=1), even when the video elementary stream of the video object is continuously input to the video buffer 212, naturally the video buffer does not generate an overflow. In addition, the video picture to be output is seamlessly reproduced while maintaining a favorable picture quality.

Incidentally, in the perfect seamless state, the IDR picture (IDR) may not necessarily be arranged at the front of the video elementary stream. When the video elementary stream is reproduced so that no inconsistency is generated in the parameters in the video elementary stream which will be newly input, the state is set to a perfect seamless state (SML_FLG=1, SML_EX_FLG=1). For example, the case in which the originally continuous video elementary stream is simply severed to be divided into two video objects (EVOB) corresponds to the perfect seamless state.

In the general information (M_EVOB_GI) of the video object for movies shown in FIG. 9, the recording start time (EVOB_REC_TM) of the VBO is described in addition to the video object type (EVOB_TYP). This recording time corresponds to the record start time of the front portion of the video object. When the front portion is erased at the recording time, the erased time is calculated, and the recording start time (EVOB_REC_TM) is rewritten. In addition, in this general information (M_EVOB_GI), the start presentation time stamp (EVOB_V_S_PTM) showing the reproduction start time (presentation time stamp: PTS) of the initial video field or video frame in the video object, and the end presentation time stamp (EVOB_V_E_PTM) showing the reproduction end time (presentation time stamp: PTS) of the last video field or video frame in the video object are described. These time stamps (EVOB_V_S_PTM, EVOB_V_E_PTM) are either copied or calculated to be described from parameters defined in the MPEG standard.

Furthermore, in each of the information (M_EVOBI#1 through M_EVOBI#n) of the video objects for movies, seamless information (SMLI) is described for seamlessly reproducing the video object to the previous video object (EVOB) as shown in FIG. 9. The seamless information (SMLI) is described when symbol “1b” is described in the seamless flag (SML_FLG). The seamless information (SMLI) includes a first SCR (EVOB_FIRST_SCR) of the video object for describing the system time clock (SCR) of the front pack included in the video object, and the last SCR (PREV_EVOB_LAST_SCR) of the previous video object for describing the system time clock (SCR) of the last pack included in the previous video object (EVOB) rather than the video object.

When the last SCR (PREV_EVOB_LAST_SCR) of this previous video object is attained, the reproduction system (player for reproduction) detects this SCR (PREV_EVOB_LAST_SCR), and the system clock is rewritten to the first SCR (EVOB_FIRST_SCR) in accordance with this detection. Consequently, the next video object (EVOB) can be seamlessly reproduced continuously in time following the previous video object (EVOB).

Furthermore, in each of the information (M_EVOBI#1 through M_EVOBI#n) of the video objects for movies, the audio gap information (AGPI) and the video object time map information (EVOB_TMAPI) concerning the video objects (EVOB) are described as shown in FIG. 9. In the audio gap information (AGPI), information of the time point of the interruption of the audio stream in the video object (EVOB) in the case of such audio interruption and the time period thereof is described. The EVOB time map information (EVOB_TMAPI) includes general information (EVOB_TMAP_GI) concerning the time map of the video object (EVOB). In the general information (EVOB_TMAP_GI), the number of the video object unit (VOBU) constituting the video object (EVOB) is described. The start address (ADR_OFS) within the recording region 132 having the video object (EVOB) recorded thereon is described in the relative logic block number from the front of the recording region 132. Furthermore, the size or the like of the video objects is described there. That is, in the general information (VTMAP_GI) of the video time map, the start address (ADR_OFS) of the video object (EVOB) is described in a relative block number from the front logical block of the object file (movie file (HR_MOVIE_VRO)) for video recording) which is recorded on the VR object group recording region 132, and the final address of the video time map (VTMAP) is described in the relative logical block number from the front of the video time map (VTMAP). Furthermore, the number of the video map search points (VTMADPI_SRP) within the video time map (VTMAP) or the like is described there.

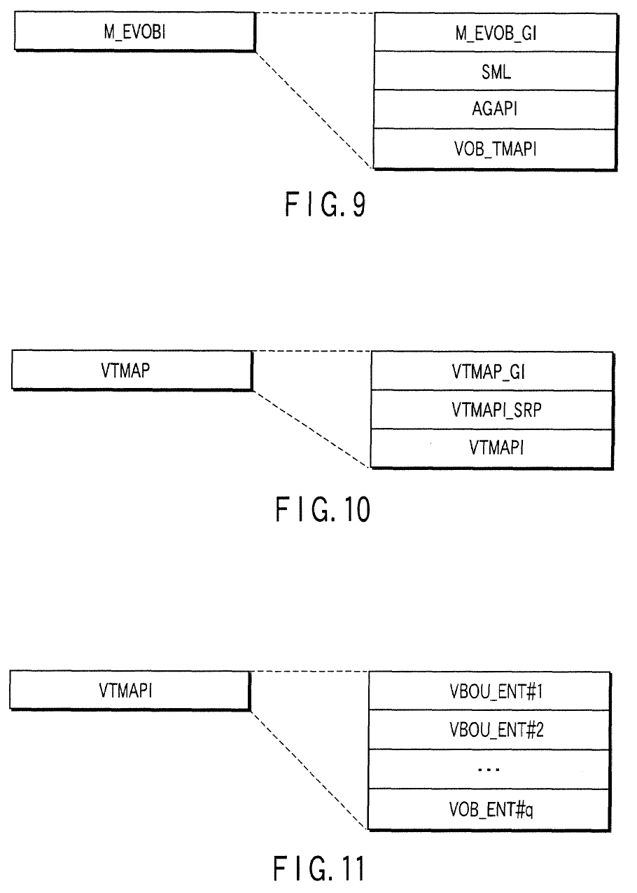

Furthermore, the movie AV file information table (EX_M_AVFIT) shown in FIGS. 5 and 6(b) includes a time map table (VTMAPT) concerning the video object (EVOB). The video time map table (VTMAPT) includes a video time map (VTMAP) as shown in FIGS. 5 and 10. This video time map (VTMAP) includes general information (VTMAP_GI) of the video time map, the video map search pointers (VTMADPI_SRP) and the video map information (VTMAPI). The video map search pointer (VTMADPI_SRP) is provided in the number of the video objects (EVOB) recorded in the VR object group recording region 132 shown in FIG. 4. In this video map search pointer (VTMADPI_SRP), an index number for specifying the recorded video object (EVOB) is described, and the address of the video map information (VTMAPI) which is searched with the search pointer (VTMAPI_SRP) is described.

The video map information (VTMAPI) includes EVOBU entries (VOBU_ENT#1 through #q) for describing the entry points of the video object units (VOBU) constituting the video objects (EVOB) specified with the index number as shown in FIG. 11. In each of the EVOBU entries (VOBU_ENT#1 through #q), the size (VOBU_SZ) of each video object unit (VOBU) and the reproduction time thereof (VOBU_TM) are described. A relative start address (VOBU_ADR#i) of a certain video object unit (VOBU#i) is given in the sum of video object units from the video object unit (VOBU#1) within the video object (EVOB) up to the video object unit (VOBU#(i−1)) which is one unit ahead of the corresponding video object unit (VOBU#i). An address of each of the video object units (VOBU) from the front of the movie file (HR_MOVIE_VRO) for video recording is determined by using the address offset (ADR_OFS) of the video object unit (EVOB) described in the general information (EVOB_TMAP_GI) of the video object time map within the information (EVOB_TMAPI) of the video object time map shown in FIG. 9. The address is determined by adding the sum of the video object units to the address offset (ADR_OFS) of the video object unit (EVOB). Furthermore, the presentation start time (VOBU_START_TM#i) of the video object unit (VOBU#i) is given in the sum of the presentation start time of the video object units from the video object unit (VOBU#1) up to the video object unit (VOBU#(i−1)) which is one unit ahead of the corresponding video object unit (VOBU#i) in the same manner.

The HDVR video manager (HDVR_MG) shown in FIG. 6(a) includes an original program chain information table (ORG_PGCIT) for regulating the reproduction order of the video object unit (VOBU) and a user defined program chain information table (ORG_PGCIT) for regulating the reproduction order of the video object unit (VOBU) defined by the user. When the video signal and the audio signal such as broadcasting or the like are encoded as they are and are recorded on the recording region 132 as the video object (EVOB), the original program chain information table (ORG_PGCIT) is prepared as the navigation data to be recorded on the HDVR video manager (HDVR_MG) as it is. In the case where the video object (EVOB) comprising the video object (EVOB) defined in the reproduction order on the original program chain information table (ORG_PGCIT) is edited by the user, and the reproduction order of the video object unit (VOBU) after edition is defined, the user defined program chain information table (ORG_PGCIT) is prepared as a new navigation data to be recorded on the HDVR video manager (HDVR_MG).

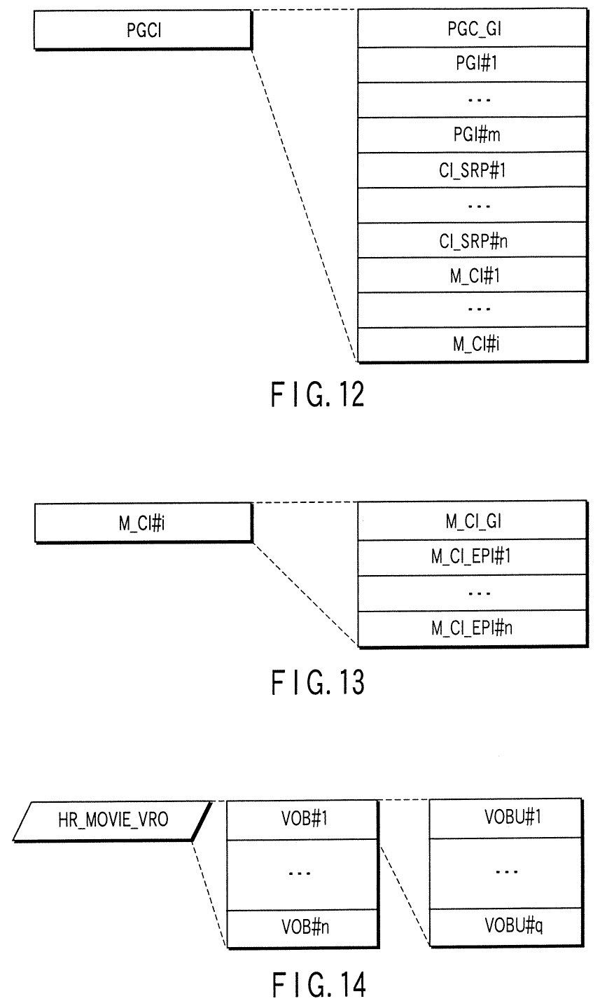

Both the original program chain information table (ORG_PGCIT) and the user defined program chain information table (ORG_PGCIT) include program chain information as shown in FIG. 12. The program chain information (PGCI) includes program chain general information (PGC_GI) arranged at the front thereof, program information (PG#1 through PG#m) concerning programs included in the program chain (PGC), cell search pointers (CI_SRP#1 through #n) for searching movie cell information (M_CI#1 through #n) and the movie cell information (M_CI#1 through #n).

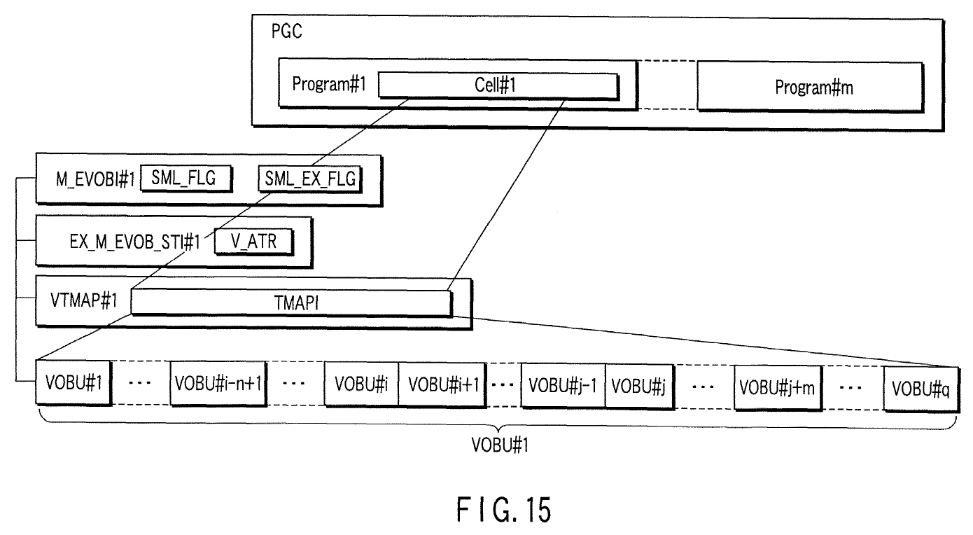

There will be briefly explained the program chain (PGC), the program (PG), the cell (C) and the video object unit (VOBU) by referring to FIGS. 14 and 15.

As has been explained by referring to FIGS. 4(f) and 4(g), the video object unit (VOBU) 142 is object data. The video object unit (VOBU) is defined as a pack sequence in which the video pack 145 (V_Pack) and the audio pack (A_Pack) 146 are multiplexed which begin from the real-time data information pack (RDI_PACK: Real-Time Data Information) 144. As shown in FIG. 14, one or pluralities of these video object units (VOBU) are combined to constitute one video object (EVOB#1 through EVOB#n). These video objects (EVOB#1 through EVOB#n) are recorded in the recording region 132 shown in FIG. 4(d) as a movie video recording (HR_MOVIE_VRO) file.

The program chain (PGC), the program (PG) and the cell (C) are navigation data for navigating the reproduction, namely navigation data showing the reproduction order. One or a plurality of movie cells (C) constitutes a program (PG), and one or a plurality of programs (PG) constitutes a program chain (PGC). The cell (C) specifies the video object units (VOBU) which are reproduced (presented) at first and finally as shown in FIG. 15, with the result that the video object units (VOBU) which are continuous in time are reproduced (presented) one after another between the video object units (VOBU) to be reproduced (presented) at first and finally, thereby reproducing the video. The first and the final video object units (VOBU) specified in the cell (C) are specified with the start presentation time (S_PTM) and the end presentation time (E_PTM). Consequently, the video time map information (VTMP) is referred to with the start presentation time (S_PTM) and the end presentation time (E_PTM) with the result that the address of the corresponding video object unit (VOBU) is specified to be presented (reproduced). Consequently, one cell (C) which is provided with a certain cell number specifies a video object unit (VOBU) within the video object (EVOB) whereas another cell (C) which is provided with a cell number which follows the former cell number can specify the video object unit within another video object (EVOB). Consequently, the program (PG) comprising a plurality of cells or the program chain (PGC) specifies a video object unit (VOBU) which belongs to a plurality of video objects (EVOB) with the result that the video object unit (VOBU) can be continuously presented.

As shown in FIG. 12, in the program chain general information (PGCI_GI) of the program chain information (PGCI), as shown in FIG. 12, the number (PG_Ns) of programs (PG#1 through PG#n) and the number (CI_SRP_Ns) of the cell search pointers (CI_SRP#1 through #m) are described. Furthermore, in the program information (PGI#1 through PGI#m), the number of cells (C) constituting respectively the program (PG), the number of object cells which are reproduced with the program (PG) and the like are described. The reproduction of the cells following the object cells (C) at first is continued until the number of cells (C) constituting the program (PG) is attained by increasing this cell number. In the cell search pointers (CI_SRP#1 through #i) which are arranged in the reproduction order, the start address (CI_SA) of the movie cell information (M_CI#1 through #i) is described in a relative block number from the first byte of the program chain information (PGCI).

Furthermore, each of the movie cell information (M_CI) comprises, as shown in FIG. 13, general information (M_CI_GI) of movie cells, and information (M_CI_EPI#1 through #n) of movie cell entry points. In the general information (M_CI_GI) of the movie cells, the numbers of the search pointers (EVOBI_SRP) of the video object information which are shown in FIGS. 5 and 6(b) corresponding to the video objects to which the video object units (VOBU) designated by the cells (C) belong are described. The search pointers (EVOBI_SRP) of the video objects are arranged in an order of increasing numbers within the movie AV file information (EX_M_AVFI) with the result that the video object information (EVOBI) can be obtained by specifying the search pointers (EVOBI_SRP) through specifying the number of the search pointers (EVOBI_SRP).

Furthermore, in each of the general information (CI_GI#1 through #n) of the movie cells, the number (C_EPI_Ns) of the information (M_CI_EPI#1 through #n) of the movie cell entry points, the presentation time (C_V_S_PTM) at the video start time of the cells (C) and the presentation time (C_V_E_PTM) at the video end time of the cells (C) are described. By referring to the general information (VTMAP_GI) of the video time map using this presentation times (C_V_S_PTM) and (C_V_E_PTM), the start address (ADR_OFS) of the first video object unit (VOBU) constituting the cells (C) and the start address (ADR_OFS) of the final video object unit (VOBU) can be obtained.

In the information (M_CI_EPI#1 through #n) of the movie cell entry points, the entry point presentation time (EP_PTM) is described as the information concerning the entry points used respectively by the user with the result that the skip (FF skip or the FR skip) designated by the user at the entry point described in the information (M_CI_EPI#1 through #n) of the movie cell entry points can be realized. When the input is given by the user, the entry point presentation time (EP_PTM) designated by the user is referred to with the result that the start address (ADR_OFS) of the video object (EVOB) constituting the cell (C) can be obtained by referring to the general information (VTMAP_GI) of the video time map using this time stamp.

### (Processing Flow at the Recording Time)

In the recording and reproducing apparatus shown in FIG. 1, encoding the analog video and audio data at the recording processing unit 100 allows the analog video to be converted into coded video data to be stored in the packet of the video pack (V_Pack) 145. Furthermore, the audio data are stored in the pack of the audio pack (A_Pack) 145 to be multiplexed. The RDI packet (RDI) 146 is created from the information or the like at the encoding time with the result that the video object units (VOBU) 142 are created which are stored in the scope having approximately a definite length which units are provided with a RDI pack at the front thereof. When the video object units (VOBU) 142 are input to the disk control unit 102 one after another, the video object units (VOBU) 142 are temporarily stored in the memory with the result that the video objects (VOBU) 140 are created from a plurality of video object units (VOBU) 142. The information at the time of coding, the information of the cell (C), the information of the program (PG) and the information of the original program chains (ORG_PGC) are collected in the creation of the video objects (EVOB) 140, with the result that the information of the manager is created and the HDVR manager (HDVR_MG) which has been explained by referring to FIGS. 4 through 13 is created. This HDVR manger (HVVR_MG) is recorded on the management information recording region 130, and the created video objects (EVOB) are recorded on the VR group recording region 132 one after another. Since the video objects (EVOB) are not edited at this recording time, the user defined PGCI table (UD_PGCIT) is not recorded, and the table remains as an empty region.

Next, there will be explained a processing in the case where the video objects (EVOB) are edited after being recorded on the disk 300.

### (Non-Seamless Edition Method) (SML_FLG=0, SML_EX_FLG=0)

In the beginning, in the data structure of the optical disk 300 as shown in FIG. 1, there will be explained an example in which the start point and the end point of a section in which the original video objects (EVOB) should be erased are designated in the reproduction time with the result that the original video objects (EVOB) are divided and erased on the basis of the designation of the erasure section.

As shown in FIG. 15, in the presence of one original video objects (EVOB#1), as has been already explained, the movie video object (EVOB#1) shown in FIGS. 5, 7 and 9, the video time map (VTMAP) shown in FIGS. 5 and 10 and the movie video object stream information (EX_EVOB_STI) shown in FIGS. 5 and 7 are prepared individually along with the original video object (EVOB#1), and information with respect to the video object (EVOB#1) is described therein. Furthermore, in the original program chain (ORG_PGC), at least one cell (C) is created which corresponds to the original video object (EVOB).

Furthermore, the information (M_VOB#1) of the movie video object is created, and a seamless flag (SML_FLG) and a seamless extension flag (SML_EX_FLG) are described in that information. Furthermore, in the information (EX_M_VOB_STI#1) of the movie video object unit stream, a video attribute (V_ATR) is described. Furthermore, in the video time map (VTMAP#1), the information (VTMAPI) of the time map is described, and the entry point (VOBU_ENT) of each video object unit (VOBU#n) in the video object (EVOB) is described.

Incidentally, in the following explanation, it is explained that the edition of the original video object (EVOB) is conducted in the boundary of the video object unit (VOBU). It is thought that the video data are coded in the MPEG-4AVC in the video attribute (V_ATR).

### (Video Object (EVOB) and Division of Related Information)

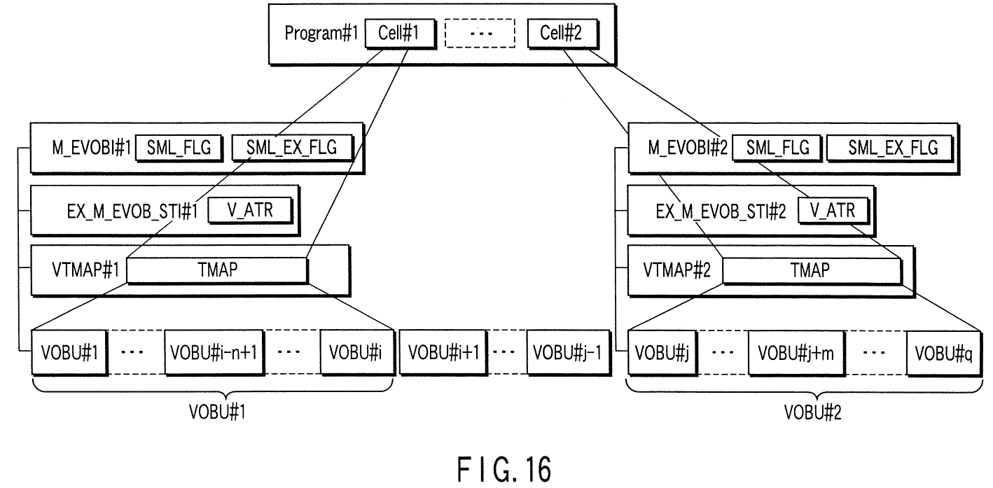

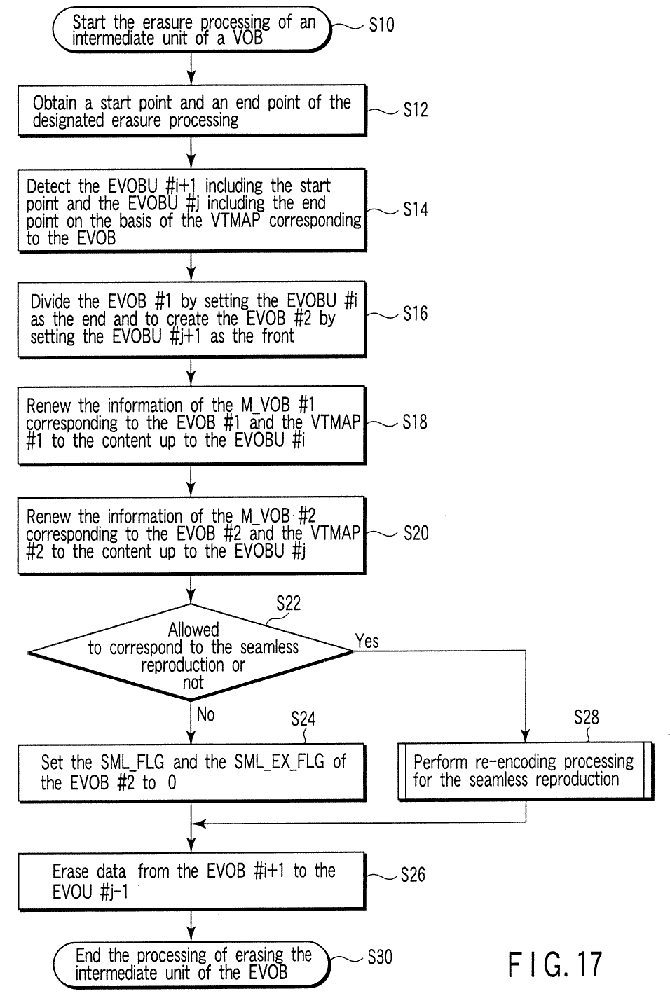

FIG. 16 is a view showing a flow of processing of erasing parts in an original video object (EVOB). In the beginning, when the processing of erasing parts in an original video object (EVOB) is started (S10), a section (a start point and an end point of the erasure processing) of the video object unit (EVOB) which becomes an erasure object in the original video object (EVOB) is determined from the video time map (VTMAP) shown in FIG. 10 corresponding to the video object (EVOB), with the result that the start point and the end point of the designated erasure processing is obtained at the recording processing unit 101 (S12). As shown in FIG. 16, when the video object unit (VOBU) immediately before the erasure thereof is defined as a video object unit (VOBU#i), and the final video object unit (VOBU) which is erased is defined as a video object unit (VOBU#j−1), the video object units (VOBU) from the video object unit (VOBU#i+1) corresponding to the start point of the erasure processing to the video object unit (VOBU#j−1) corresponding to the end point of the erasure processing are defined as an actual erasure object. Here, the video map (VTMAP) is referred to so that the addresses of the video object unit (VOBU#i+1) corresponding to the start point and the video object unit (VOBU#j−1) corresponding to the end point are determined with the result that the video object unit (VOBU#i+1) corresponding to the start point and the video object unit (VOBU#j−1) corresponding to the end point are detected among the video objects (EVOB).

Incidentally, there is a case in which the video object unit (VOBU) which is an erasure object is also required in the edition processing which will be described later. Consequently, a perfect erasure processing is conducted at the final step of the edition processing as will be explained later.

The video object (EVOB#1) is divided, as shown in FIG. 16, by setting the video object unit (VOBU#i) as the end with the result that the video object unit (VOBU) after the video object unit (VOBU#j) is created as a new video object (VOBU#2). (S16) The video object (VOBU#1) and the new video object (VOBU#2) are managed at the HDVR manager (HDVR_MG). That is, the contents of the video time map (VTMAP#1) corresponding to the video object (EVOB#1), the information (EVOBI#1) of the video object, and the information (EVOB_STI#1) of the video object stream are renewed in such a manner that the contents correspond to the video object (EVOB#1) after the division processing. (S18) In the same manner, the contents of the video time map (VTMAP#1) corresponding to the new video object (EVOB#2), the information (EVOB#1) of the video object and the information (EVOB_ST#1) of the video object stream are renewed in such a manner that the contents correspond to the video object (EVOB#1) after the division processing. (S20) That is, since information corresponding to each of the video object units (VOBU) is described in the video time map (VTMAP), the video map (VTMAP#1) is changed in such a manner that the video map has information up to the video object unit (VOBU#i) with the result that the information after the video object unit (VOBU#j) is given to a newly divided video map (VTMAP#2).

Furthermore, a user defined PGC information table (UD_PGCIT) is created, and movie cell information (M_CI) concerning the newly created video object (EVOB) by the division is created as shown in FIG. 13. The PGC information (PGCI) shown in FIG. 12 is created as a set of information (M_CI) of this movie cell.

In the same manner, the information (EVOB_ST#1) of the video object stream includes attribute information concerning the video object (EVOB#2). Since the video object (EVOB#1) and the video object (EVOB#2) basically have the same attribute, the information (EVOB_STI#2) of the video object stream concerning the video object (EVOB#2) is set on the basis of the information (EVOB_STI#1) of the video object stream.

In the case where a seamless flag (SML_FLG) concerning the seamless playback is given in a video object type (EVOB_TYP) of the information (EVOB#1) of the video object, the seamless playback ceases to be guaranteed owing to the erasure of a part of the video object (EVOB). Consequently, it is judged at step S22 whether or not the seamless playback is conducted at the time of the continuous reproduction of the new video object (EVOB#1) and the video object (EVOB#2). Here, in the case where the seamless playback is not required, “0” is set as a value of the seamless flag (SML_FLG) in the information (EVOBI#2) of the M_video object, and “0” is also set as a value of the seamless extension flag (SML_EX_FLG). (S24) Thereafter, as shown at step S26, the video object unit (VOBU#j−1) is erased from the video object unit (VOBU#i+1) shown in FIG. 16 regarded as an object of the erasure processing. As shown at step S30, the erasure processing of the intermediate portion of the video object (EVOB) is ended. At the time of the erasure thereof, a sequence end code (SEQ_END_CODE) is added to the rear end of the video elementary stream of the video object unit (VOBU#j).

At step S22, in the case of corresponding to the seamless playback, a part of the video object (EVOB) is subjected to re-encoding processing for the seamless playback. Setting required for the seamless playback which will be described later is conducted. As shown at step S26, the video object unit (VOBU#j−1) is erased from the video object unit (VOBU#i+1) which is followed by ending the processing at step S30.

Incidentally, in the case where the video object (EVOB#2) is already present before the division of the video object (EVOB#1), the new video object (EVOB#2) is added with the result that the previous video object (EVOB#2) is renewed to a video object (EVOB#3) and the related information is renewed in the same manner.

### (Operation for Realizing the Seamless Reproduction)

Next, there will be explained a concrete edition processing for guaranteeing the seamless playback. As has been already explained in the prior art, the seamless playback cannot be guaranteed only with the erasure processing of a part of the video object (EVOB). This is because the buffer state is different between the previous and the following video objects (EVOB) in the state in which the part is simply erased, with the result that there is a possibility that a buffer error is generated. In addition, this is because there is a possibility that reference pictures of the B picture or the P picture are absent owing to the erasure of the part so that the decoding processing cannot be correctly performed. Consequently, the following basic processing is required in order to enable the seamless playback.

In the embodiment of the present invention, two-stage levels are defined as the edition processing for realizing the seamless playback, and the two-stage levels are classified with the flag (SML_FLG, SML_EX_FLG). On one level, problems such as the buffer state, the reference frame or the like are settled with the result that a continuous reproduction is enabled with the decoder at the reproduction time. However, this level is such that a special correspondence is required at the side of the decoder in the state in which inconsistency remains partially between parameters. In this specification, this level is defined as “a semi-seamless state” as has been already described. In the semi-seamless state, as has been already explained by referring to FIGS. 5 and 9, it is defined by using a newly defined seamless extension flag (SML_EX_FLG) in addition to the seamless flag (SML_FLG) that when the seamless flag (SML_FLG) and the seamless extension flag (SML_EX_FLG) are set to “0”, the reproduction is not seamless. It is described that when the seamless flag (SML_FLG) is set to “1” and the seamless extension flag (SML_EX_FLG) is set to “0”, the reproduction is semi-seamless. The other level is such that a seamless playback is realized with a simple mechanism at the time of reproduction by taking measures against inconsistency of parameters to provide a perfect guarantee of the continuity of the video stream between video objects (EVOB). The level is defined as “a perfect seamless state”. In the perfect seamless connection state, the seamless flag (SML_FLG) is represented in a value of “1” and the seamless extension flag (SML_EX_FLG) is represented in a value of “1” with the result that both “seamless” and “semi-seamless” are represented as being sufficient.

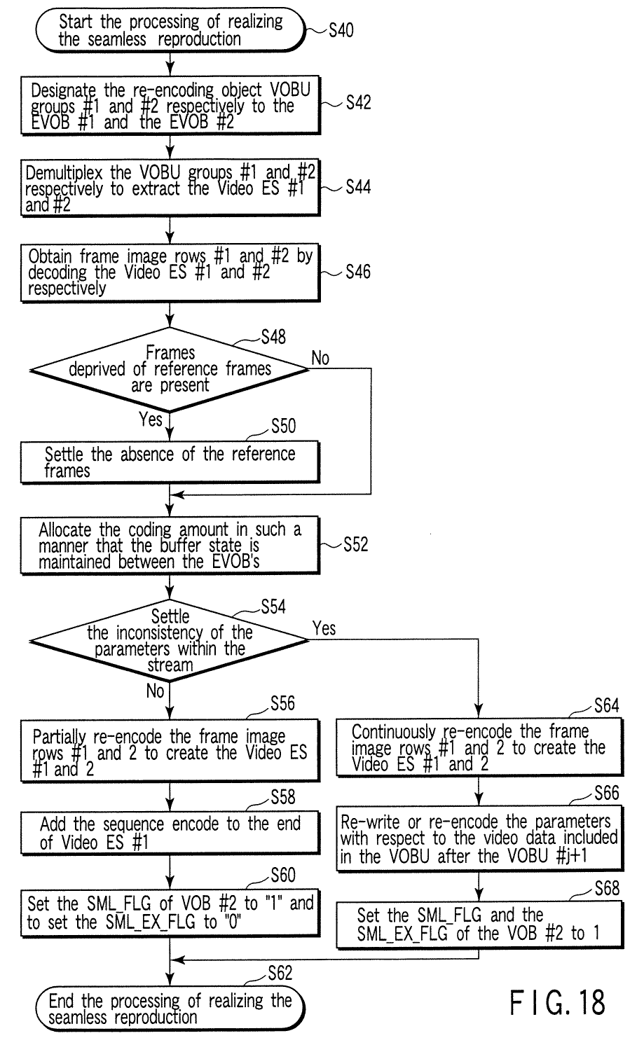

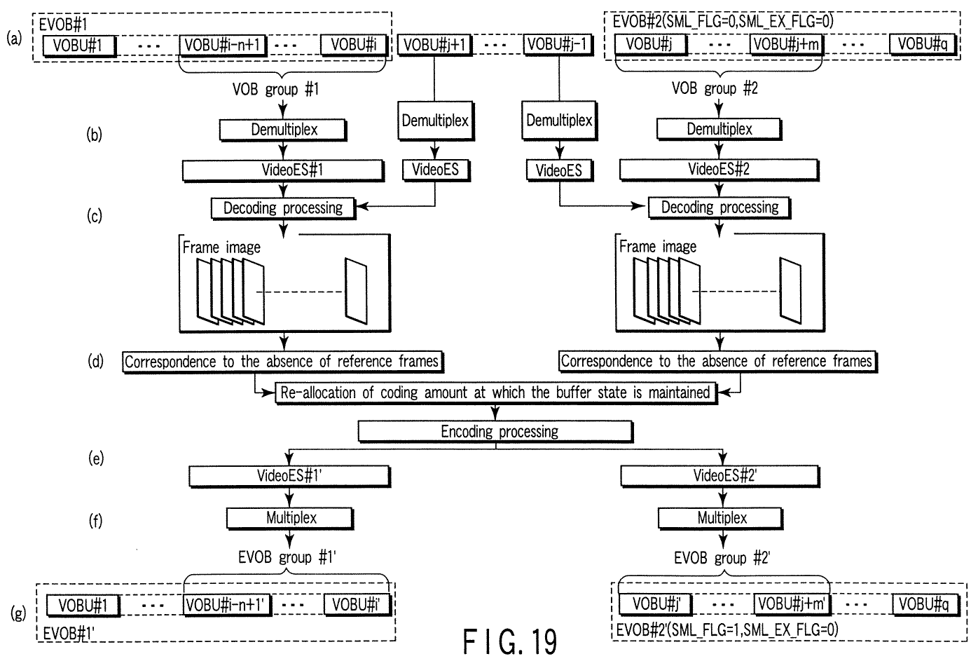

There will be explained edition processing for realizing the seamless playback by referring to FIGS. 18 and 19. Here, FIG. 18 is a view showing a flow of the edition processing for realizing the seamless playback including the perfect seamless playback and the semi-seamless playback. Furthermore, FIG. 19 is an outline showing a concept of a conversion processing for realizing the semi-seamless state.

In the beginning, there will be explained a processing for realizing the semi-seamless state (SML_FLG=1, SML_EX FLG=0).

### (Specification of Location of the Partial Re-Encoding)

At step S40 shown in FIG. 18, when the processing for realizing the seamless playback is started, parts (for example, n or m video object units (VOBU)) of the divided new video object (EVOB#1) and the video object (EVOB#2) described with reference to FIG. 16 are designated as a group of video object units (VOBU) which will be re-encoded. (S42) That is, as shown in FIG. 19(a), video object units (VOBU) (from the video object unit (VOBU#i−n+1) to the video object unit (VOBU#i)) in the n (n is an integer) portions of the ends of the video objects (EVOB#1) are regarded as objects of re-encoding to be set as video object unit (VOBU) groups #1 respectively. Furthermore, first m (m is an arbitrary integer) portions of video object units (VOBU) (from the video object unit (VOBU#j) up to the video object unit (VOBU#j+m−1) are regarded as targets of re-encoding to be set as a video object unit (VOBU) group #2.

Incidentally, when the values of n and m are larger, the coding amount at the time of re-encoding can be flexibly allocated. For that portion, the processing cost increases with the result that the values of n and m are set in consideration of a balance between the processing cost and the re-encoding quality.

### (AV Separation of the Partial Video Object Unit (VOBU))

As shown in FIG. 19(b), a de-multiplexing processing is performed with respect to the target video object unit (VOBU) groups set as described above with the result that the groups are separated into video elementary streams (V_ES) (Elementary Stream) and audio elementary streams (Audio ES) (S44). Here, the video elementary stream (V_ES) separated from the video object unit (VOBU#1) group is set as the #1 video elementary stream (V_ES#1) while the video elementary stream (V_ES) separated from the video object unit (VOBU#2) group is set as the #2 video elementary stream (V_ES#2).

### (Reproduction of Buffer Model)

Next, a processing is performed for maintaining a buffer model. In the beginning, the code amount of each picture in the #1 video elementary stream (V_ES#1) is obtained with the result that the buffer transition state in the video object (EVOB#1) is reproduced. Incidentally, in order to reproduce the buffer state of the video object (EVOB#1) accurately, the whole video object (EVOB#1) is de-multiplexed and the whole video elementary stream (V_ES) is extracted. Although it is required to investigate the transition of the coding amount, the buffer state is virtually reproduced only with the information of the video object unit (VOBU) group #1 in the present embodiment.

The same processing is performed with respect to the #2 video elementary stream (V_ES#2) with the result that the transition of the buffer state is reproduced. The buffer states of the #1 video elementary stream and the #2 video elementary stream are compared to check whether or not a buffer error is generated. Consequently, the allocation amount of the coding amount at the re-encoding is adjusted in such a manner that the error is not generated. The reallocation of this coding amount is required to be performed in consideration of the change of the slice type at the re-encoding processing which will be described later.

### (Creation of the Decoding Image)

Next, with respect to the #1 video elementary stream (V_ES#1) and the #2 video elementary stream (V_ES#2), a decoding processing is performed for the re-encoding processing as shown in FIG. 19(c) with the result that a frame picture is created. (S46) At this time, there arises a case in which no reference picture is present in the extracted video elementary stream (V_ES). (S48) In the case of the #1 video elementary stream (V_ES#1), this is generated in the case where a slice (either the P picture or the B picture) is present which has a picture included after the video object unit (VOBU#i+1) as a reference frame out of the pictures included in the video object unit (VOBU#i). In the case of the normal H.264 or MPEG-4AVC, in order to decode such pictures, it is required that the decoding is performed by decoding reference pictures present from the previous IDR pictures up to the following IDR pictures to create reference frames.

On the other hand, in the case of the H.264 or MPEG-4AVC, the video object unit (VOBU) always includes one slice, the data structure is limited to inhibit reference over one slice in the coding order with the result that it is possible to guarantee the inclusion of the reference picture in the immediately previous or the immediately following video object unit (VOBU) even in the absence of the reference picture in the video object unit (VOBU). Consequently, in the case where the data structure is limited in such a manner, the video object unit (VOBU) group #1 is subjected to AV separation together with the following video object unit (VOBU#i+1) or the like as shown in FIG. 19(b) to perform the decoding. In the same manner, as shown in FIG. 19(b), the video object unit (VOBU) #2 is subjected to decoding together with the previous video object unit (VOBU#j−1) with the result that the state of the absent state of the reference picture can be avoided.

### (Settlement of the Absence of Reference Pictures)

On the other hand, in the seamless playback, it is required to perform a smooth reproduction of the video object (EVOB#2) following the video object (EVOB#1). After the edition described above, in the case where the absence of the reference pictures is generated (S48), as shown in FIGS. 19(d) and 19(e), it is required to settle the state of the absence of the reference picture at the re-encoding time. (S50)

As a method for dealing with the state of the absence of the reference picture, there are available a plurality of methods. Here, there will be explained only some representative examples thereof. As a simple method, there is available a method for coding pictures having no reference pictures as one picture. However, in this case, the coding amount which is consumed increases. As another method, there is available a method for re-making a motion prediction only with respect to the frame which is present in the video object unit (VOBU) as a target. In the case where a two-way prediction is made with the B picture, only the motion vector having a reference picture may be re-used to perform again the motion compensation processing.

When the absence state of this reference picture is settled, as has been already explained, an appropriate coding amount is given to the video elementary stream in such a manner that the buffer state is maintained between the video objects (EVOB).

### (Insertion of Sequence Encode)

In the state in which the aforementioned processing is performed, the buffer state and the absence of the reference picture are settled. However, an inconsistency is generated with respect to the following parameters between the video object (EVOB#1) and the video object (EVOB#2) (S54). frame_num

picture order count

In the case where the inconsistency of parameters in these streams is allowed at step S54, that is, in the case where a semi-seamless state is generated, the frame picture rows (picture rows #1 and #2) are partially re-encoded as has been already described as shown in FIG. 19(e) with the result that #1, #2 video elementary streams (ES#1 and #2) are created. (S56)

Incidentally, in the inconsistency of the parameters described above, the decoder side assumes in advance the case of the generation of such inconsistency. When the point of the generation of such inconsistency can be recognized with the decoder, it is possible to deal with the inconsistency as an exception processing at the decoding time. There will be explained a concrete method for dealing with the inconsistency in the item of the processing of the reproducing device described later.

When the front of the following video object (EVOB#2) is an IDR picture, the inconsistency of the aforementioned parameters is not generated. However, in the case where the stream is partially erased as has been explained by referring to FIG. 16, it is difficult to guarantee that the front of the following video object (EVOB#2) is an IDR picture. The reason is that, as has been already explained, inputting the IDR picture in the unit of the video object unit (VOBU) leads to a large decrease in the coding efficiency.

As described above, at the time of the partial erasing edition, it is difficult to detect with the decoder the change-over of the stream with the IDR picture. Therefore, adding the sequence code (SEQ_END_CODE) to the end of the #1 video elementary stream (V_ES#1) of the video object (EVOB#1) enables the decoder to detect the timing of the change-over of the #1 video elementary stream (V_ES#1) and the #2 video elementary stream (V_ES#2) which are input to the decoder. (S58) In the case of H.264, the NAL unit of (end_of_seq_rbsp) is added.

### (Flag Setting)

As has been described above, in the case where the coding format of pictures is the H.264 or MPEG-4AVC at the state of performing the processing, the seamless flag (SML_FLG) is set to “1” while the seamless extension flag (SML_EX_FLG) is set to “0” (Setting of Semi-Seamless State: S60)

### (Re-Mixing)

With respect to the video elementary stream (V_ES#1 and #2) with which the re-encoding processing is ended, the audio data and the other data (RDI, GCI or the like) are mixed again to form a MPEG-2PS format as shown in FIG. 19(f). As shown in FIG. 19(g), the video object (EVOB#1) and the video object (EVOB#2) are formed. When the re-encoded data are allocated to the disk, the allocation is performed in the form which follows a jump performance model of the disc on the basis of the minimum unit called a CDA which must be continuously present on the disk with the result that recording is performed on the disc 300.

Furthermore, the information required for the seamless playback using an expanded system target decoder (E-STD: Extended System Target Decoder) model such as a gap of audio data, and the start SCR and the end SCR of the video object (EVOB#1 and #2) is appropriately set with the same method as the conventional method.

### (Perfect Seamless State) (SML_FLG=1, SML_EX_FLG=1)

In the aforementioned explanation, there has been explained a processing method for realizing a semi-seamless state in the minimum partial re-encoding of the video object (EVOB). In the aforementioned method, the processing cost at the edition time is relatively small, but it is required to devise the seamless playback on the side of the decoder at the decoding time. On the other hand, there will be explained herein below a processing method for realizing a perfect seamless state for reliably performing a seamless playback with more decoders.

As a concrete method, the buffer state is maintained in accordance with a flow shown in FIG. 18 (S40 through S52). In the case where the inconsistency of the parameters is settled at step S54, the re-encoding processing is performed with respect to the whole #2 video elementary stream (V_ES#2) in such a manner that a perfect continuity can be guaranteed with the previous #1 video elementary stream (V_ES#1) and the following #2 video elementary stream (V_ES#2). That is, the whole frame picture row (picture rows #1 and #2) is re-encoded as has been already described as shown in FIG. 19(e) with the result that the #1 and the #2 video elementary streams (ES#1′ and #2′) are created. (S64) In addition, following the re-writing of the parameters, the video objects (EVOB#q) after the following video object (EVOB#j+1) are subjected to the re-encoding with the result that a new #2 video object (EVOB#2) is created. (S66) In addition, when this new video object (VB#2) is created, the seamless flag (SML_FLG=1) and the seamless extension flag (SML_EX_FLG=1) are set to “1”. (S68) Thereafter, the processing for the realization of the seamless playback is ended.

Here, in the case where the value of the seamless flag (SML_FLG) is set to “1”, in the seamless information (SMLI), there are described the first SCR (EVOB_FIRST_SCR) for describing a system time clock (SCR) of the front pack included in the video object (EVOB#1) and the last SCR (PREV_EVOB_LAST_SCR) of the previous video object for describing the system time clock (SCR) of the last pack included in the video object (EVOB#2) which comes ahead of the video object.

### (Insertion of the IDR Picture)

In consideration of the fact that originally the #1 video elementary stream and the #2 video elementary stream are not continuous owing to the erasure of parts, at step S64 for realizing the perfect seamless state, it is preferable that the front picture in the order of coding of the #2 video elementary stream (V_ES#2) is coded as an IDR picture. In this case, the relation of the reference picture changes along with the presence of the IDR picture, with the result that the reference pictures of the #1 video elementary stream (V_ES#1) and the #2 video elementary stream (V_ES#2) are reconsidered. Specifically, with respect to the reference over the picture which is coded as an IDR picture, the IDR picture is subjected again to the motion prediction and the motion vector creation processing as a reference picture. The cost of the motion prediction is omitted through re-use of the original motion vector by scaling in space along with the change of the reference frame at this time.

Incidentally, when the continuity with the #1 video elementary stream (V_ES#1) can be guaranteed, the front picture of the #2 video elementary stream (V_ES#2) may be coded to a picture other than the IDR picture. However, reference is not made over the video objects (EVOB).

### (Re-Calculation of Continuous Parameters)

On the other hand, in the case where the front of the #2 video elementary stream (V_ES#2) is coded with the IDR picture, or in the case where the front is not coded with the IDR picture, in order to reliably reproduce seamlessly the video object (EVOB#1) and the video object (EVOB#2), it is required to perform the re-encoding processing at step S66 by de-multiplexing not only the video object unit (VOBU) group #2 having m video object units (VOBU) at the front in the video object (EVOB#2) collected but also the video object units (VOBU) after m+1 video object unit to fetch the video elementary stream (V_ES).

In this re-encoding processing, a perfect re-encoding processing is not required which has been performed with respect to the #2 video elementary stream (V_ES#2) corresponding to the video object unit (VOBU) group #2, with the result that the processing can be handled in re-writing processing of the information of the slice header level. Specifically, with respect to the values of the frame_number and pic_order_cnt, the parameters of the whole video objects (EVOB#2) are corrected together with the value of the #2 video elementary stream (V_ES#2) in such a manner that the value can be changed continuously on the basis of the information of VideoES#1. Furthermore, with respect to a buffer parameter as well, the value thereof is corrected on the basis of the actual generation coding amount at the re-coding time in the #2 video elementary stream (V_ES#2) by referring to the parameters in the buffer state of the #1 video elementary stream (V_ES#1) as the basis thereof. With respect to the residual video elementary stream (V_ES), the values of the parameters are corrected one after another on the basis of the coding amount of each slice of the video elementary stream (V_ES) which is already present with respect to the buffer parameters set in the #2 video elementary stream (V_ES#2).

### (Flag Setting)

As has been described above, in the case where the re-coding processing of the whole video object (EVOB#2) is performed, and the continuity on the level of the video elementary stream (V_ES) can be guaranteed, the seamless flag (SML_FLG) is set to “1” while the seamless extension flag (SML_EX_FLG) is set to “1” in order to show the state thereof. Recording of the mixture with the audio and the information of the seamless playback is performed in the same manner as conventionally.

### (Other Examples)

Up to the aforementioned description, there has been explained the realization of the seamless playback in the case where the intermediate portion of originally one video object is erased and is divided into two video objects (EVOB). There will be described other situations for performing the seamless playback at two video objects (EVOB) and a method for setting the flags.

### (Change-Over of Real-Time Video Objects (EVOB))

In the case where a resolution or the like is changed at the time of continuously recording a certain video and audio data, there is a case in which the video objects (EVOB) are changed considering that the contents are changed over. In this case, since the recording processing itself is continuously performed, the reference picture does not become absent, and the state of the inside of the encoder is maintained at the time of the change-over of the video objects (EVOB). After the change of the video objects (EVOB), the video objects are coded while maintaining the buffer state of the immediately previous video objects (EVOB) with the result that the encoding is enabled in a prefect seamless state (SML_FLG=1, and SML_EX_FLG). In the case where the attribute is changed with the change-over of the video object (EVOB), the front picture of the following video objects (EVOB) is coded with the IDR picture to enable changing attributes such as the resolution or the like. In the case where the aforementioned coding is performed, both the seamless flag (SML_FLG) and the seamless extension flag (SML_EX_FLG) are set to “1”.

### (Connection of the Two Video Objects Having Different Attributes)

In the case where an attempt is made to seamlessly reproduce video objects (EVOB) which are recorded at different timings in comparison with the change-over of the video objects (EVOB) in real time as has been described above, basically it is required to conduct re-encoding. The situation in this case is approximately the same as the situation in the case in which one video object (EVOB) is erased at the intermediate portion thereof. When the front of the following video objects (EVOB) is coded in advance with the IDR picture (IDR), a perfect seamless state can be realized by maintaining the buffer state between the video objects (EVOB) through re-encoding and erasing the absence of the reference picture of the foregoing video object (EVOB). On the other hand, in the case where the front of the following video objects (EVOB) ceases to be an IDR picture in the edition processing, the seamless reproducible state can be realized by selecting either the semi-seamless state or the perfect seamless state in the same method as in the case where one video object (EVOB) is erased at the intermediate portion thereof. For example, a semi-seamless state is generated by re-encoding and correcting only the buffer state without changing the front picture of the following video object (EVOB) into an IDR picture, a perfect seamless state is generated by re-encoding the front of the following video object (EVOB) with the IDR picture and correcting the following parameters.

### <Processing Flow at the Time of Reproduction>

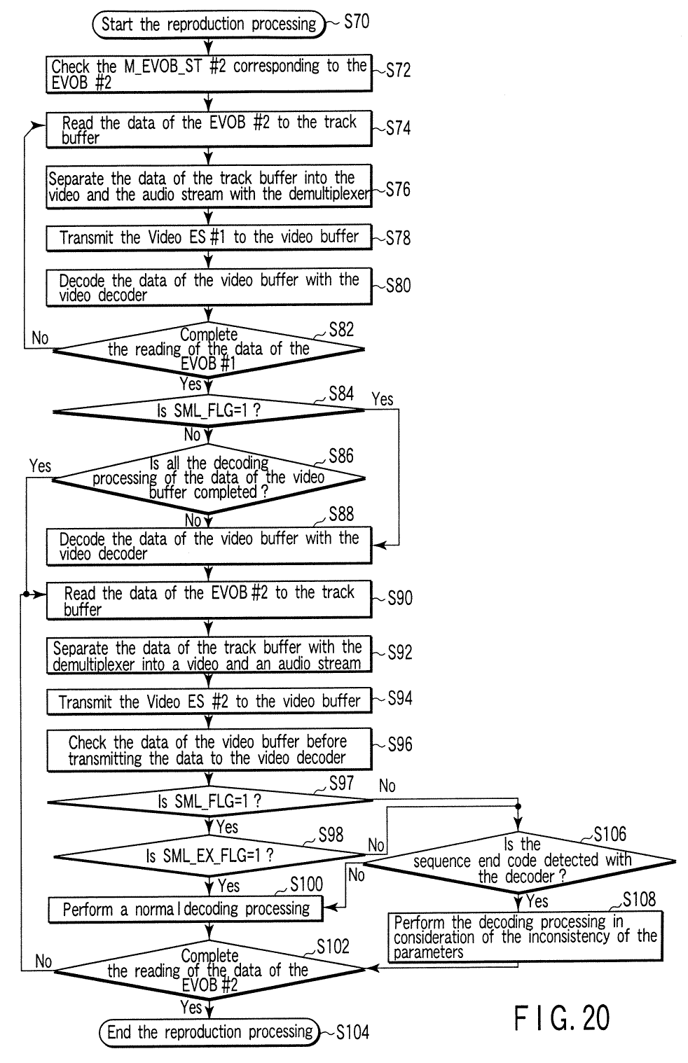

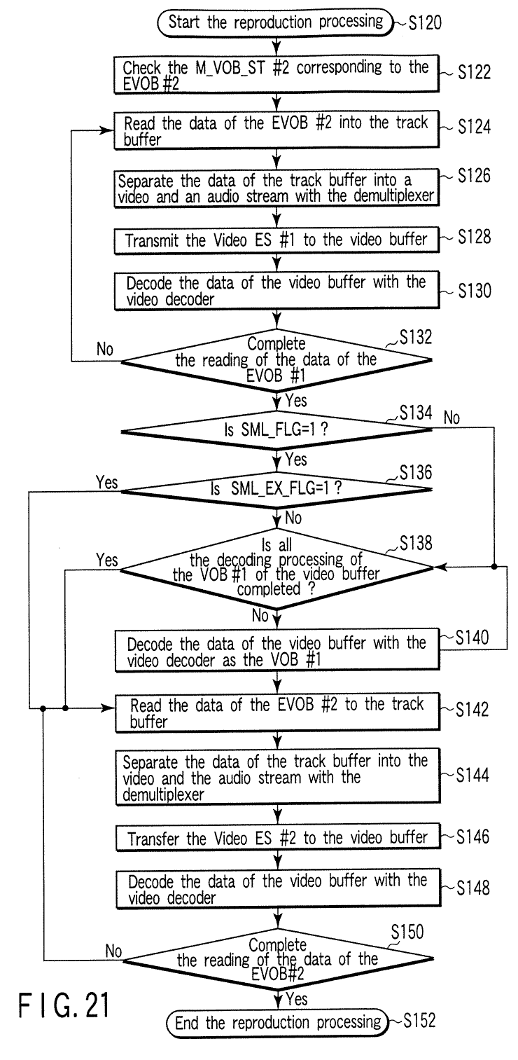

Next, there will be explained an example as to how the contents to which the flag is set is reproduced on the reproduction side. In this embodiment, there will be explained a case in which reproduction is performed from the video object (EVOB#1) to the video object (EVOB#2) continuously. In the reproduction processing, the processing is different depending on whether or not the decoder side has a capacity of enabling the seamless playback in the semi-seamless state. The reproduction processing flow in the case of the decoder which corresponds to the seamless playback in the semi-seamless state is shown in FIG. 20. The processing flow in the case of the decoder which does not correspond to the semi-seamless state is shown in FIG. 21.

### (Seamless Reproduction from the #1 Video Object (EVOB#1) to the #2 Video Object (EVOB#2))

In FIGS. 20 and 21, when the processing of the seamless playback from the #1 video object (EVOB#1) to the video object (EVOB#2) is started (S70 and S120), the information (EVOBI#2) of the video objects associated with the video objects (EVOB#2) which will be reproduced next and the information (EVOB_STI#2) of the video object stream are checked at the time of transition of the reproduction order designated by the program chain (PGC) from the video object (EVOB#1) to the video object (EVOB#2). (S72 and S122) In particular, at the time of the seamless playback, the information (V_ATR) of the video attributes included in the video objects (EVOB_STI#2), the information of the seamless flag (SML_FLG) and the seamless extension flag (SML_EX_FLG) included in the information (EVOB#2) of the video objects and, if present, the seamless information (SMLI) are checked.

Here, the video compression mode is regarded as being definite within the disc 300. In the case where the video compression mode is an H.264 or MPEG-4AVC, it is set in such a manner that an output from the decoder 216 is changed over to a re-order buffer 220 with the result that the order of the decoded picture is re-arranged in the reproduction order to be output, based on the information of the seamless flag (SML_FLG) and the seamless extension flag (SML_EX_FLG) set at the time of recording as described above.

In this state, the data of the #2 video objects (EVOB#2) is read to a track buffer (not shown) of the disk processing unit 102 (S72 and S124) with the result that the data of the track buffer are separated into the video and the audio elementary streams at the de-multiplexer 210 (S76 and S126).

The #1 video elementary stream (V_ES#1) which has been de-multiplexed at the outset is transmitted to the video buffer 212 (S78 and S128) while the data stored in the video buffer 212 are decoded one after another at the video decoder (S82 and S130). Thus, the picture data are arranged in order at the re-ordering buffer 220 to be output.

At steps S82 or S134, it is checked as to whether or not the reading of the video object (EVOB#1) is completed. When the reading thereof is not completed, the process returns to step S74 or S124 with the result that steps S74 through S82 or steps S124 through S132 are repeated. In the case where the reading of the video object (EVOB#1) is completed, the seamless flag (SML_FLG) is checked. (S84 and S134) In the case where the seamless flag (SML_FLG) is “0” at steps S84 and S124, the processing is performed as a non-seamless processing which will be explained below.

The processing following the steps S84 and S134 is different between the reproducing device which corresponds the semi-seamless state and the reproducing device which does not correspond to the semi-seamless state with the result that the processing will be explained respectively with respect to FIGS. 20 and 21.

### (At the Time of Non-Seamless State)

### <Non-Seamless Flow Corresponding to the Semi-Seamless State Shown in FIG. 20>

When the seamless flag (SML_FLG) is set to “0” and the seamless extension flag (SML_EX_FLG) is set to “0”, the seamless playback of the video object (EVOB#1) and the video object (EVOB#2) is not guaranteed. Consequently, after the data of the video object (EVOB#1) are separated to transmit the video data to the video pack, the completion of the processing of the data of the video buffer with the decoder is waited for. Then, the decoder is once initialized followed by transmitting the video data of the video object (EVOB#2) again so that the reproduction can be performed. In this case, since the transmission of the buffer is suspended as one process, the reproduction is temporarily suspended with the change-over of the video object (EVOB#1) and the video object (EVOB#2).

That is, in the reproducing device corresponding to the semi-seamless state, as shown at step S86 of FIG. 20, it is checked as to whether the video data in the video buffer 212 are all decoded. In the case where the video data are not all decoded at step S86, the data within the video buffer 212 are decoded at the video decoder 216 one after another until all the data within the video buffer 212 are decoded. (S88) In the case where the data within the video buffer 212 are all decoded at the video decoder 216 at step S88, or in the case where the video data are all decoded at step S86, the data of the video object (EVOB#2) are read into the track buffer (S90), and the data of the track buffer are separated into the video and the audio elementary streams at the de-multiplexer 210. (S92) This #2 video elementary stream (V_E_#2) is transmitted to the video buffer 212. Before the #2 video elementary stream (V_ES_190 2) within the video buffer 212 is decoded, the seamless flag (SML_FLG), the seamless extension flag (SML_EX_FLG) and the sequence end code (SEQ_ENT_CODE) are checked. (S96) In the case where the seamless flag (SML_FLG) is set to “0” at step S97, and the seamless extension flag (SML_EX_FLG) is set to “0”, it is judged to be non-seamless. At step S106, the detection of the sequence end code (SEQ_END_CODE) is checked. When the sequence end code (SEQ_END_CODE) is detected, the decoding processing in consideration of the inconsistency of parameters is performed (S108). Thereafter, it is confirmed at step S102 whether or not the reading of the data of the video object (EVOB#2) is completed. In the case where the reading of the data of the video object (EVOB#2) is not completed, the same processing from step S90 to step S108 at the non-seamless playback is performed.

In the case where the sequence end code is not detected with the decoder 216 at step S106, the normal decoding processing is performed at step S100 in the non-seamless state. In the same manner, it is confirmed at step S102 as to whether the reading of the data of the video object (EVOB#2) is completed. In the case where the reading of the data of the video object (EVOB#2) is not completed, the same processing from step S90 to step S105 in the non-seamless playback is performed.

### <Non-Seamless Flow Which Does not Correspond to the Semi-Seamless State Shown in FIG. 21>

In the case where the seamless flag (SML_FLG) is set to “0” at step S134, the reproduction is conducted in the non-seamless state. In the non-seamless state, as shown at step S138, it is checked as to whether the video data in the video buffer 212 are all decoded or not. In the case where the video data are not all decoded at step S86, the data within the video buffer 212 are decoded one after another with the video decoder 216 until all the data of the video object (EVOB#1) within the video buffer 212 are decoded. (S140) In the case where the data in the video buffer 212 are all decoded with the video decoder 216 at step S138, the data in the video object (EVOB#2) are read into the track buffer (S142) and the data in the track buffer are separated into the video and the audio elementary streams with the de-multiplexer 210. (S144) This #2 video elementary stream (V_ES#2) is transmitted to the video buffer 212. (S146) The decoding of the data of the video object (EVOB#2) in the video buffer 212 is started with the result that the steps S142 through S148 are repeated until the reading of all the data of the video object (EVOB#2) into the video buffer 212 is completed. When the reading of all the data of the video object (EVOB#2) is completed, the reproduction processing is ended. (S152)

### (At the Time of Seamless State)

There will be explained a processing of the semi-seamless playback in which the seamless flag (SML_FLG) is set to “1” and the seamless extension flag (SML_EX_FLG) is set to “0” as a flag representing a seamless condition.

In this condition, a perfect continuity is not guaranteed on the level of the video elementary stream (V_ES). Seamless information (SMLI) for securing the consistency of the buffer state or for absorbing shifts of time stamp or the like are set, and the seamless properties of the E-STD buffer model on the system level are guaranteed. It becomes necessary to take specific measures to perform a seamless playback with the decoder.

Depending on whether or not the decoder can take such specific measures, specifically the procedure at the reproduction time is different in the same manner as the processing in the non-seamless state.

### <Semi-Seamless Flow Corresponding to the Semi-Seamless State Shown in FIG. 20>

Since the seamless flag (SML_FLG) is set to “1” at step S84 in the semi-seamless state, the data of the video buffer 212 continues to be decoded at the video decoder 216 while the data in the video object (EVOB#2) are read into the track buffer. The data of the video object (EVOB#2) within the track buffer are separated into the video and the audio elementary streams with the de-multiplexer 210. (S92) This #2 video elementary stream (V_ES#2) is transmitted to the video buffer 212. Before the #2 video elementary stream (V_ES#2) within the video buffer 212 is decoded, the seamless flag (SML_FLG), the seamless extension flag (SML_EX_FLG) and the sequence end code (SEQ_END_CODE) are checked. (S96) In the semi-seamless state, at step S97, the seamless flag (SML_FLG) is set to “1” and at step S98, the seamless extension flag (SML_EX_FLG) is set to “0” with the result that, at step S106, the detection of the sequence end code (SEQ_END_CODE) is checked. When the decoder 216 detects the sequence end code (SEQ_END_CODE: end_of_seq_rsbp) which is present in the video buffer, the decoder 216 detects the generation of the inconsistency of the parameter level with the video data of the following buffer from the state of the seamless flag (SML_FLG) and the seamless extension flag (SML_EX_FLG). Here, the decoder 216 once resets the inside state while leaving the video buffer as it is. Then, when the data following the sequence end code (end_of_seq_rsbp), namely the video data of the video object (EVOB#2) are decoded, the decoding processing is performed in advance as an exceptional processing. (S108) In this manner, the inconsistency of the video data is detected on the decoder level, and the processing is performed continuously with the result that the seamless playback is enabled depending on the processing performance of the decoder. In the processing after step S108, it is confirmed at step S102 whether or not the reading of the data of the video object (EVOB#2) is completed. In the case where the reading of the data of the video object (EVOB#2) is not completed, the processing is performed which is the same as the processing at step S90 to S108 in the non-seamless playback.

In the case where the detector 216 does not detect the sequence end code (end_of_seq_rsbp) at step S106, the normal decoding processing is performed at step S100 in the seamless state. In the same manner, it is confirmed at step S102 whether or not the reading of the data of the video object (EVOB#2) is completed. In the case where the reading of the data of the video object (EVOB#2) is not completed, the processing is performed which is the same as the processing from step S90 to S106 in the semi-seamless playback.

As has been described above, in the reproducing processing using a decoder corresponding to the seamless playback in the semi-seamless state, in order to realize the seamless playback, the video data of the video object (EVOB#2) is continuously transmitted to the video buffer following the video data of the video object (EVOB#1). In the decoder, the data of the video buffer are sequentially subjected to a decoding processing.

### <Semi-Seamless Flow Which Does Not Correspond to the Semi-Seamless State Shown in FIG. 21>

Since the seamless flag (SML_FLG) is set to “1” in the semi-seamless state at step S136, the data of the video object (EVOB#2) are read into the track buffer at step 142, and the data of the track buffer are separated into the video and the audio elementary streams with the de-multiplexer 210. (S144) This #2 video elementary stream (V_ES#2) is transmitted to the video buffer 212. (S146) The decoding of the data of the video object (EVOB#2) within the video buffer 212 is started. Until the reading of all the data of the video object (EVOB#2) within the video buffer 212 is completed, the steps S142 to S148 are repeated. When the reading of all the data of the video object (EVOB#2) is completed, the reproducing processing is ended. (S152)

Incidentally, even when the sequence end code (end_of_seq_rbsp) is detected, there is present a decoder which cannot seamlessly reproduce the decode of the pictures in which the inconsistency of the parameters is generated which are created later. In this case, as shown in FIG. 21, in the same manner as at the time when the seamless flag (SML_FLG) is set to “0”, it becomes possible to conduct the reproduction by transmitting the data of the video object (EVOB#2) after waiting for the video decoder to complete the processing of the video data of the video object (EVOB#1).

### (At the Time of the Perfect Seamless State)

When the seamless flag (SML_FLG) is set to “1” and the seamless extension flag (SML_EX_FLG) is set to “1”, the continuity on the level of the video elementary stream (V_ES) is guaranteed. Consequently, on the video encoding side, the video data of the video object (EVOB#2) are continuously input to the video buffer 201 following the video data of video object (EVOB#1). A seamless decoding processing is enabled by continuously decoding the input buffer on the video decoder side. Thereafter, on the basis of other seamless related information, a synchronicity is taken with the system to perform the reproduction. In more detail, in the semi-seamless correspondence shown in FIG. 20 and the semis-seamless non-correspondence shown in FIG. 21, the flows thereof are different as described below.

### <Flow of Perfect Seamless Reproduction Corresponding to the Semi-Seamless Reproduction Shown in FIG. 20>

In the perfect seamless state, since the seamless flag (SML_FLG) is set to “1” at step S84, the data of the video buffer 212 continue to be decoded at the video decoder 216 while the data of the video object (EVOB#2) are read into the track buffer. The data of the video object (EVOB#2) in the track buffer are separated into the video and the audio elementary streams at the de-multiplexer 210. (S92) This #2 video elementary stream (V_ES#2) is transmitted to the video buffer 212. Before decoding the #2 video elementary stream (V_ES#2) within the video buffer 212, the seamless flag (SML_FLG), the seamless extension flag (SML_EX_FLG) and the sequence end code (SEG_END_CODE) are checked. (S96) In the perfect seamless state, the seamless flag (SML_FLG) is set to “1” at step S97, and the seamless extension flag (SML_EX_FLG) is set to “1” at step S98 with the result that a normal decoding is performed at steps S100. (S100) Thereafter, at step S100, the processing of the data of the video object (EVOB#2) is performed while it is confirmed at step S102 as to whether or not the reading of the data of the video object (EVOB#2) is completed. In the case where the reading of the data of the video object (EVOB#2) is not completed, the same processing as the processing at steps S90 through S106 in the perfect seamless playback is performed.

As has been described above, in the reproduction processing using a decoder corresponding to the semi-seamless playback in the perfect seamless state, for the realization of the seamless playback, the video data of the video object (EVOB#2) is continuously transmitted to the video buffer following the video data of the video object (EVOB#1). At the decoder, the data of the video buffer are sequentially subjected to the decoding processing.

### <Perfect Seamless Flow Which Does Not Correspond to the Semi-Seamless State Shown in FIG. 21>

Since the seamless flag (SML_FLG) is set to “1” in the perfect seamless state in the same manner as the semi-seamless state at step S136, at step S142, the data of the video object (EVOB#2) are read into the track buffer with the result that the data of the track buffer are separated into the video and the audio elementary streams with the de-multiplexer 210. (S144) This #2 video elementary stream (V_ES#2) is transmitted to the video buffer 212. (S146) The decoding of the data of the video object (EVOB#2) within the video buffer 212 is started with the result that steps S142 to S148 are repeated until the reading of all the data of the video object (EVOB#2) is completed in the video buffer 212. When the reading of all the data of the video object (EVOB#2) is completed, the reproduction processing is ended. (S152)

As has been described above, a semi-seamless state is set between the prefect seamless state and the non-seamless state. Even in the reproducing apparatus corresponding to this semi-seamless state, or even in the reproducing apparatus which does not correspond to the semi-seamless state, the video stream can be reproduced on the aforementioned three levels with the result that the reproduction can be made smoothly between the video objects.

According to the present invention, the flag for the seamless playback is expanded and the state between the video objects (EVOB) is represented in a stepwise manner, with the result that even with the video object (EVOB) coded with H.264, a seamless playback can be realized at a small processing cost by means of a partial re-encoding.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording medium comprising:
an audio and video recording region defined between a lead-in region and a lead-out region, the audio and video recording region having a management information recording region on which rewritable management information is recorded, and an object group recording region on which rewritable video objects are recorded;
each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and
the management information recording region including a video manager which manages the video object, the video manager including stream information describing video attributes in which the video elementary stream is coded in a coding format defined in an H.264, the video manager including video object information having describing a seamless flag and a seamless extension flag specifying that the video objects are continuously and seamlessly reproduced for each of the video objects, and a combination of the seamless flag and the seamless extension flag allows a two-level seamless playback.

2. The medium according to claim 1, wherein the information of the video object stream includes video compression information having described therein a video compression mode showing that the coding mode of the video elementary stream is an MPEG-4AVC or H.264.

3. The medium according to claim 1, wherein the seamless flag includes a flag “1” showing that the video objects which are continuous in terms of time are seamlessly reproduced, and the seamless extension flag includes a flag “1” showing that the video elementary stream of the video object which comes behind other video object in terms of time is coded so as to be reproduced subsequent to the video object which comes ahead of the other video objects in terms of time.

4. The medium according to claim 1, wherein the seamless flag includes a flag “1” showing that the video object is seamlessly reproduced, and the seamless extension flag includes a flag “0” showing that a sequence encode code is included at the end of the video elementary stream of the video object which comes ahead of the other video objects in terms of time, and that a part of the video elementary stream of the video object which comes behind in terms of time following this video elementary stream is reproducibly coded subsequent to the video object which comes ahead in terms of time.

5. The medium according to claim 1, wherein the seamless flag includes a flag “1” showing that the first and second video objects are seamlessly reproduced, the information of the video object includes seamless information, and
a first system time clock of the video object and a final system time clock of the video object which comes ahead of the former video object are described in this seamless information.

6. The medium according to claim 1, wherein the video object information includes information of an entry point in which the entry point in the object group recording region of the video object unit constituting the video object is described.

7. A reproducing apparatus which reproduces video data from a recording medium which comprises:
an audio and video recording region defined between a lead-in region and a lead-out region, the audio and video recording region having a management information recording region on which rewritable management information is recorded, and an object group recording region on which rewritable video objects are recorded;
each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and
the management information recording region including a video manager which manages the video object, the video manager including stream information describing video attributes in which the video elementary stream is coded in a coding format defined in an H.264, the video manager including video object information having describing a seamless flag and a seamless extension flag specifying that the video objects are continuously and seamlessly reproduced for each of the video objects, and a combination of the seamless flag and the seamless extension flag allows a two-level seamless playback, the apparatus comprising:
a reproducing unit which search the recording medium to read a video manager from the management information recording region, and read the video object from the object group recording region on the basis of this video manager;
a de-multiplexing unit which de-multiplexes the video object unit to separate it into a video elementary stream and an audio elementary stream;
a video buffer which stores the video elementary stream;
a video decoder which decodes the video elementary stream output from this video buffer to output the stream as a frame picture row;
an output unit which converts the frame picture row into a video signal to output the signal; and
a control unit which controls the video elementary stream to the video buffer in accordance with the seamless flag and the seamless extension flag.

8. The apparatus according to claim 7, wherein the information of the video object stream includes information of video compression having described therein a video compression mode showing that the coding mode of the video elementary stream is H.264, and
the decoder is set in accordance with the video compression mode.

9. The apparatus according to claim 7, wherein the seamless flag includes a flag “1” showing that the video object which continues in terms of time is seamlessly reproduced, and the seamless extension flag includes a flag “1” showing that the video elementary stream of the video object which comes behind in terms of time is reproducibly coded subsequent to the video object which comes ahead in terms of time.

10. The apparatus according to claim 7, wherein the seamless flag includes a flag “1” showing that the video object is seamlessly reproduced, and the seamless extension flag includes a flag “0” showing that a sequence encode code is included at the end of the video elementary stream of the video object which comes ahead of the other video objects in terms of time, and that a part of the video elementary stream of the video object which comes behind in terms of time following this video elementary stream is reproducibly coded subsequent to the video object which comes ahead in terms of time;
wherein the video encoder detects the sequence end code to allow the input of the video elementary stream.

11. The apparatus according to claim 7, wherein the seamless flag includes a flag “1” showing that the first and second video objects are seamlessly reproduced, the information of the video object includes the seamless information, and a first system time clock of the video object and a final system time clock of a video object which comes ahead of the video object are described in the seamless information; and
the control unit renews a clock of the apparatus to the first system time clock by detecting the final system time clock.

12. The apparatus according to claim 7, wherein the information of the video object includes the information of entry points having described therein entry points in the object group recording region of the video object unit constituting the video object; and
the control unit retrieves the video object by referring to the entry points.

13. A reproduction method for reproducing video data from a recording medium which comprises:
an audio and video recording region defined between a lead-in region and a lead-out region, the audio and video recording region having a management information recording region on which rewritable management information is recorded, and an object group recording region on which rewritable video objects are recorded;
each of the video objects comprising video object units, the video object units being respectively multiplexed with an RDI pack, a video pack and an audio pack to form a pack sequence, the RDI pack storing therein navigation data for navigating the video packs being arranged at the front of the pack sequence, and the video pack storing video data belonging to a video elementary stream defined in the H.264; and
the management information recording region including a video manager which manages the video object, the video manager including stream information describing video attributes in which the video elementary stream is coded in a coding format defined in an H.264, the video manager including video object information having describing a seamless flag and a seamless extension flag specifying that the video objects are continuously and seamlessly reproduced for each of the video objects, and a combination of the seamless flag and the seamless extension flag allows a two-level seamless playback, the method comprising:
searching the recording medium to read a video manager from the management information recording region, and read on the basis of this video manager the video object from the object group recording region;
de-multiplexing the video object unit to separate the video object unit into a video elementary stream and an audio elementary stream to store the video elementary stream;
storing the video elementary stream;
decoding the video elementary stream output from this video buffer to output the stream as a frame picture row;
converting the frame picture row into a video signal to output the signal; and
controlling the video elementary stream to the video buffer in accordance with the seamless flag and the seamless extension flag.

14. The method according to claim 13, wherein the information of the video object stream includes the information of video compression having described therein a video compression mode showing that the coding mode of the video elementary stream is H.264; and
the decoding mode is set in accordance with the video compression mode.

15. The method according to claim 13, wherein the seamless flag include a flag “1” showing that the video object which continues in terms of time is seamlessly reproduced, and the seamless extension flag includes a flag “1” showing that the video elementary stream of the video object which comes behind in terms of time is coded so as to be reproduced subsequently to the video object which comes ahead in terms of time.

16. The method according to claim 13, wherein the seamless flag includes a flag “1” showing that the video object is seamlessly reproduced, and the seamless extension flag includes a flag “0” showing that a sequence encode code is included at the end of the video elementary stream of the video object which comes ahead of the other video objects in terms of time, and that a part of the video elementary stream of the video object which comes behind in terms of time following this video elementary stream is reproducibly coded subsequent to the video object which comes ahead in terms of time; and
the sequence end code is detected to allow the seamless playback.

17. The method according to claim 13, wherein the seamless flag includes a flag “1” showing that the first and second video objects are seamlessly reproduced, the information of the video object includes the seamless information, and a first system time clock of the video object and a final system time clock of a video object which comes ahead of the video object are described in the seamless information; and
the final system time clock is detected with the result that the clock is renewed to the first system time clock.

18. The method according to claim 13, wherein the information of the video object includes the information of entry points having described therein entry points in the object group recording region of the video object unit constituting the video object; and
the video objects are retrieved by referring to the entry points.

19. A recording apparatus comprising:
an encoder which converts an audio signal and a video signal into an audio stream and a video elementary stream coded with the H.264;
a multiplexer unit which stores the audio stream in an audio pack, stores the video elementary stream in a video pack to multiplex the audio pack and the video pack, and creates a video object unit in which an RDI pack for navigating a multiplexed pack sequence is arranged at the front;
a formatter which defines video objects which are respectively constituted of one or more video object units and which includes stream information and video object information to create a video manager which manages the video objects, wherein video attributes showing that the video elementary stream is coded with the coding format defined in the H.264 are described in the stream information, the video object information describes a video object type in which a seamless flag and a seamless extension flag are described which show that the video object can be continuously and seamlessly reproduced for each of the video objects, with the result that the formatter creates a video manager in which two levels of seamless playback are guaranteed with the combination of the seamless flag and the seamless extension flag;
a recording control unit which records the video manager and the video objects on a recording medium comprising an audio and video recording region defined between lead-in and lead-out regions, the audio and video recording region including a rewritable management information recording region and a rewritable object group recording region; wherein the video manager is recorded on the management information recording region while the video objects are recorded on the object group recording region.

20. The apparatus according to claim 19, wherein the information of the video object stream includes the information of video compression having described therein a video compression mode showing that the coding mode of the video elementary stream is H.264.

21. The apparatus according to claim 20, wherein the seamless flag include a flag “1” showing that the video object which continues in terms of time is seamlessly reproduced, and the seamless extension flag includes a flag “1” showing that the video elementary stream of the video object which comes behind in terms of time is coded so as to be reproduced subsequently to the video object which comes ahead in terms of time.

22. The apparatus according to claim 20, wherein the seamless flag includes a flag “1” showing that the video object is seamlessly reproduced, and the seamless extension flag includes a flag “0” showing that a sequence encode code is included at the end of the video elementary stream of the video object which comes ahead of the other video objects in terms of time, and that a part of the video elementary stream of the video object which comes behind in terms of time following this video elementary stream is reproducibly coded subsequent to the video object which comes ahead in terms of time.

23. The recording apparatus according to claim 20, wherein the seamless flag includes a flag “1” showing that the first and second video objects are seamlessly reproduced, the information of the video object includes the seamless information, and a first system time clock of the video object and a final system time clock of a video object which comes ahead of the video object are described in the seamless information.

24. The apparatus according to claim 20, wherein the information of the video object includes the information of entry points having described therein entry points in the object group recording region of the video object unit constituting the video object.

25. A recording method comprising the steps of:
encoding an audio signal and a video signal into an audio stream and a video elementary stream coded with the H.264;
storing the audio stream into an audio pack and storing the video elementary stream into a video pack to multiplex the audio pack and the video pack, thereby creating an RDI pack for navigating a multiplexed pack sequence in the video object unit which is arranged at the front;
formatting for defining two or two video objects respectively comprising one or more video object units, and creating a video manager which includes stream information and video object information and manages the video objects, wherein video attributes showing that the video elementary stream is coded with the coding format defined with the H.264 are described in the stream information, the video object information described a video object type in which a seamless flag and a seamless extension flag are described which show that the video objects can be continuously and seamlessly reproduced for each of the video objects, with the result that two levels of seamless playback are guaranteed with a combination of this seamless flag and the seamless extension flag;
recording the video manager and the video objects on a recording medium comprising an audio and video recording region defined between lead-in and lead-out regions, the audio and video recording region including a rewritable management information recording region and a rewritable object group recording region, wherein the video manager is recorded in the management information recording region, and the video objects are recorded on the object group recording region.

26. The method according to claim 25, wherein the information of the video object stream includes the information of video compression having described therein a video compression mode showing that the coding mode of the video elementary stream is defined in the H.264.

27. The method according to claim 25, wherein the seamless flag include a flag “1” showing that the video object which continues in terms of time is seamlessly reproduced, and the seamless extension flag includes a flag “1” showing that the video elementary stream of the video object which comes behind in terms of time is coded so as to be reproduced subsequently to the video object which comes ahead in terms of time.

28. The method according to claim 25, wherein the seamless flag includes a flag “1” showing that the video object is seamlessly reproduced, and the seamless extension flag includes a flag “0” showing that a sequence encode code is included at the end of the video elementary stream of the video object which comes ahead of the other video objects in terms of time, and that a part of the video elementary stream of the video object which comes behind in terms of time following this video elementary stream is reproducibly coded subsequent to the video object which comes ahead in terms of time.

29. The method according to claim 25, wherein the seamless flag includes a flag “1” showing that the first and second video objects are seamlessly reproduced, the information of the video object includes the seamless information, and a first system time clock of the video object and a final system time clock of a video object which comes ahead of the video object are described in the seamless information.

30. The method according to claim 25, wherein the information of the video object includes the information of entry points having described therein entry points in the object group recording region of the video object unit constituting the video object.
